(19) United States
(12) Patent Application Publication
(10) Pub. No.: US 2019/0080425 A1
(43) Pub. Date: Mar. 14, 2019

(54) Method and Systems for Providing On-demand Real Estate Related Products and Services

(71) Applicant: TrendGrab, Inc., San Clemente, CA (US)

(72) Inventors: Tommy Bui, San Clemente, CA (US); Mark Paulson, San Clemente, CA (US); Brian Sweeney, Newport Beach, CA (US)

(73) Assignee: TrendGrab, Inc

(21) Appl. No.: 16/004,262

(22) Filed: Jun. 8, 2018

Related U.S. Application Data
(60) Provisional application No. 62/557,652, filed on Sep. 12, 2017.

(51) Int. Cl. G06Q 50/16; G06F 17/30; G06N 5/02; G06Q 50/00

(52) U.S. Cl. CPC G06Q 50/16; G06Q 50/01; G06N 5/022; G06F 17/30967

(57) ABSTRACT

A computing device includes one or more memory devices, one or more processors and computer-readable instructions executable by the one or more processors, the computer-readable instructions to cause the computing device to 1) receive real estate product selection from real estate customer; 2) receive real estate meeting request time value and real estate meeting location from the real estate customer; 3) generate query including the real estate product selection, the real estate meeting request time value and the real estate meeting location; 4) communicate the query including the real estate product selection, the real estate meeting request time value and the real estate meeting location to a database server; 5) receive, in real time from the database server, one or more recommended real estate agents based at least in part on the real estate product selection, the real estate meeting request time and the real estate meeting location.

### RELATED APPLICATIONS

This application claims priority to U.S. provisional patent application Ser. No. 62/557,652, filed Sep. 12, 2017 and entitled “Method and Systems for Providing On-Demand Real Estate Related Products and Services,” the disclosure of which is hereby incorporated by reference.

### BACKGROUND OF INVENTION

Many different transactions and interactions are required between a potential home buyer (“Users”) and various real estate products and services providers involved (e.g., including but not limited real estate agents, lenders, inspectors, etc. (which may be collectively referred to as “Agents)). Many of the inefficiencies are caused by the different parties wasting time trying to get in contact with each other in order to coordinate meetings.

### SUMMARY OF INVENTION

These myriad of inefficiencies in the home buying process may be alleviated by obtaining real time positional measurements, personal characteristics and parameters, and environmental conditions from a variety of sources, analyzing these obtained measurements, parameters and conditions and automatically linking interested parties in an efficient manner (e.g., in real time or on-demand). In embodiments, described herein is a method, process, and system for real estate Users and real estate Agents to more efficiently complete various aspects of the home buying process in an on-demand manner. In embodiments, Users and Agents may be able to coordinate and schedule meetings with various product and service providers in real time or on demand. Currently, the widely accepted practice by Agents and Buyers is to initiate a real estate transaction by searching for Agents, calling potential Agents, scheduling a meeting, and then holding a meeting. Many times, the calling and scheduling portion of the current process takes multiple attempts, which may lead to frustration for both the Users and Agents. In addition, this may potentially lead to a lost home sale for both parties.

### BRIEF DESCRIPTION OF DRAWINGS

FIG. 1A illustrates a system architecture of a real estate service provider matching system according to embodiments;

FIG. 1B illustrates a real estate service request screen or menu in an on-demand real estate service provider matching system according to embodiments;

FIG. 2 illustrates a service request confirmation screen according to embodiments;

FIG. 3 illustrates a block diagram of a system for estimating a real estate agent's or service provider's status and/or location according to embodiments;

FIG. 4 illustrates a diagram of utilizing machine learning or artificial intelligence to understand real estate user's preferences according to embodiments;

FIG. 5A illustrates a diagram illustrating artificial intelligence and deep learning in a home selection process accordingly to embodiments;

FIG. 5B is a flowchart illustrating a machine learning or deep learning process for the ODRESP software application to select houses of interest for a real estate user;

FIG. 6 illustrates a flowchart of an on-demand real estate agent and real estate buyer matching process according to embodiments; and

FIG. 7 illustrates a logical block diagram of the on-demand real estate service matching system according to embodiments;

FIG. 8 illustrates a flowchart of an on-demand real estate service provider and real estate service requester matching process according to embodiments; and

FIG. 9 illustrates a computing device utilized in an ODRESP system according to embodiments.

### DETAILED DESCRIPTION OF INVENTION

The foregoing, and other features and advantages of the invention, will be apparent from the following, more particular description of the preferred embodiments of the invention, the accompanying drawings, and the claims. In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

In embodiments described herein, an on-demand real estate service provider matching (“ODRESP”) system is described. This may be referred to as the ODRESP system, software system, software application. In embodiments, a real estate purchaser or customer may wish to set up and/conduct a meeting to view a property with a real estate agent. Note that although the description following herein may refer to a real estate buyer and/or purchaser, the subject matter described herein may apply (either directly or with variations) to other service provider matching situations where meetings or events need to be established or setup and then conducted or held. In embodiments, these meetings may be a real estate property location or may be via the phone. Other real estate related service providers (besides real estate property purchasers and consumers) may include, but are not limited to escrow agents, lending agents, title company representative, home inspectors, appraisers, notaries, movers, home repair contractors, home improvement suppliers, home warranty providers, architects, landscape designers (any outdoor whether plants or pools or structures), pest control providers, new home contractors, and/or home remediation providers. In embodiments, parameters, data, measurements and/or information generated and/or determined for these service providers may be a TrendGrab or ODRESP profile, Better Business Bureau (BBB) information and/or ratings, rates obtained either directly from service providers signing up to our site or indirectly via other real estate websites, information and/or parameters found on forums/chat rooms/other real estate websites, industry association websites, social media, news, and/or provider specific websites.

In embodiments, the on-demand real estate service provider matching system (ODRESP system) may include computer-readable instructions stored in one or more memory devices of the one or more service requester computing devices, one or more service provider computing devices, one or more on-demand real estate service provider matching application servers and/or one or more on-demand real estate service provider database servers. In embodiments, the computer-readable instructions may be executable by one or more processors of the one or more service provider computing devices, one or more on-demand real estate service provider matching application servers and/or one or more on-demand real estate service provider database servers in order to perform the operations and features of the on-demand real estate service provider matching system. In other words, the system may have software in the service requester computing device, the service provider computing devices, as well as software in the application servers and/or database servers, which may all interact with each other. In embodiments, this may be client-server software and/or may be distributed software. In embodiments, real estate property purchasers, real estate agents, real estate service providers and requesters may utilize many different types of computing devices to access the ODRESP system and may download application software to interface with the ODRESP system and software. In embodiments, the computing devices may include mobile computing devices, smartphones, mobile phones, tablets, laptops, desktops, wearable computing devices (e.g., glasses and/or watches), television computing devices and/or other control panels acting as a mobile computing device.

For purposes of illustration and not to be in any way limiting, the following description will make reference to a software application that improves upon the process of a real estate User searching for and scheduling a viewing of a home for sale with a real estate Agent. However, it will be appreciated that the invention is equally applicable to any aspect of the home buying process between User and Agent as well as between Agent and Agent that involves one party seeking out, researching, selecting, and scheduling a meeting with another party that is capable of providing the real estate product or service, as was listed above. In embodiments, one party may be referred to as a service provider or a real estate service provider because that party may be able to provide the real estate service or product. In embodiments, discussion may be made with reference to homes, but the discussion applies to all real estate properties including but not limited to homes, commercial real estate properties, residential apartment properties, condominiums, and even real estate lots.

In embodiments, the ODRESP software application and system may obtain information, parameters, data and/or measurements from one or more publicly available databases and/or from one or more proprietary databases, such as, one or more traffic report servers or traffic databases, one or more weather databases or weather servers, one or more newsfeeds or news databases or news servers, one or more social network servers or social network databases, one or more online forum servers or one or more online forum servers, and the MLS database. In addition, the ODRESP software application and system may other information, parameters, data and/or measurements from professional affiliations and governance groups such as the California Bureau of Real Estate. In embodiments, these organizations may keep relevant affiliation and/or license information and data in databases, which may be accessed and download to the ODRESP software and/or system system. In embodiments, gathering information from computing devices owned by professional affiliations and governance groups allow the system to keep track of relevant affiliation, license type and/or license status of relevant individuals. In embodiments, the publicly available database sources and privately available database sources may communicate and/or refresh the data, parameters, and/or measurements in the real estate service provider matching system database or database servers on a continual and/or constant basis in order to provide real time (of closed to real time) information, parameters, measurements and data updates for the on-demand real estate service provider matching system.

In an illustrative embodiment, taking a home viewing process as an example, currently real users that wish to view a home via one of the popular real estate websites such as Zillow must coordinate with a listing Agent for the home. This typically involves some form of online request and waiting for a reply. In other words, an email may be sent to a listing agent and the user has to wait until the listing agent responds. Once a reply is received from the listing Agent, the User and Agent will arrange a convenient time for the home viewing. At best, this process is not very efficient and wastes time for the User or customer who wants to view the User. At worst, the current process (such as Zillow's process) can be very frustrating and time consuming for the User or customer. Further, in a competitive housing market, a delay experienced by a real estate User in being able to view a home may result in the home being sold before the User has had a chance to view and visit the home. This same scenario is present in other parts of the home buying process such as signing of paperwork, home contractor appointments, setting up meeting with appraisers, and/or setting up meetings with home inspections.

From the perspective of the real estate Agent, the current process can be equally challenging. Agents spend a considerable amount of time and money trying to generate new leads of prospective users. Leads generated from traditional sources and more recently, from online home listing sites, are delayed and often are of poor quality. In addition, the real estate leads are not qualified enough to perform a suitable to match of the home and User with the Agent (in other words, the online systems really don't find out the characteristics of the houses that the real estate user is looking for). It is vitally important for the User to be able to work with an Agent that has experience with not only the home but also the local neighborhood characteristics, including but not limited to schools, business and retail establishments, safety, cultural events and establishment, sporting events and establishments, and/or potentially relevant parameters. Additionally, the real estate Agent's effectiveness working as a consultant to the User may contingent on that real estate Agent having experience interacting with similar user profiles (demographic, age, income, etc) When the home, real estate User, and real estate Agent profiles and/or characteristics are not aligned, this leads to a poor home buying experience. In embodiments, the on-demand real estate service provider matching (ODRESP) system and associated software application greatly improves the efficiency of a home viewing and buying process for both a real estate user and a real estate agent. In embodiments, real estate users and/or real estate agents may select a real estate buying product and service they are interested in (e.g., a viewing of a home), be shown a real time list of available agents (or service providers) that meet predefined user requirements or characteristics (which may or may not include a top recommended real estate agent (or service provider).

In embodiments, these agents (or service providers) have identified that they are available for meetings and/or transactions. In embodiments, the real estate service provider matching (ODRESP) system and associated software application may leverage and/or utilize real time user location, real time agent location, real estate agent availability and profile, artificial intelligence algorithms, as well as other factors in order to determine a recommended real estate agent (or service provider) and/or a list of recommended real estate agents that can meet at a requested or selected tie and/or a selected place specified by the real estate user. In embodiments, other factors may include, but are not limited to: user preferences, user historical interactions with the real estate service provider matching software application, and real time environmental conditions, such as current or future traffic conditions and/or current or future weather conditions. In embodiments, service requesters (e.g., real estate purchasers) may wish to meet immediately (or as soon as possible) with service providers (e.g., real estate agents). Thus, in some embodiments, if a service requester (real estate purchaser) does not input a time to meet, the default in the ODRESP software and/or system may be an immediate meeting (if not at a location) or an ASAP meeting time (e.g., as soon as a service provider (e.g., real estate agent)) may be able to meet. This is a significant improvement to the providers and requesters and results in significant efficiencies of the ODRESP system and software being able to interface users and/or purchasers immediately.

In embodiments, real estate buying products and services may include services or products required to engage in and complete a real estate transaction or viewing including but not limited to: scheduling home viewings, selecting and scheduling a notary, selecting and scheduling a lender, selecting and scheduling a home inspector, selecting and coordinating moving services, coordinating transfer of home utilities and services, selecting and scheduling contractor services, selecting a home improvement supply company, selecting and scheduling a real estate appraiser, selecting and scheduling a landscape designer, selecting and scheduling a pest control company, selecting and scheduling a home remediation provider, selecting and scheduling an architect, selecting a title company, selecting an escrow agent and/or other similar real estate services.

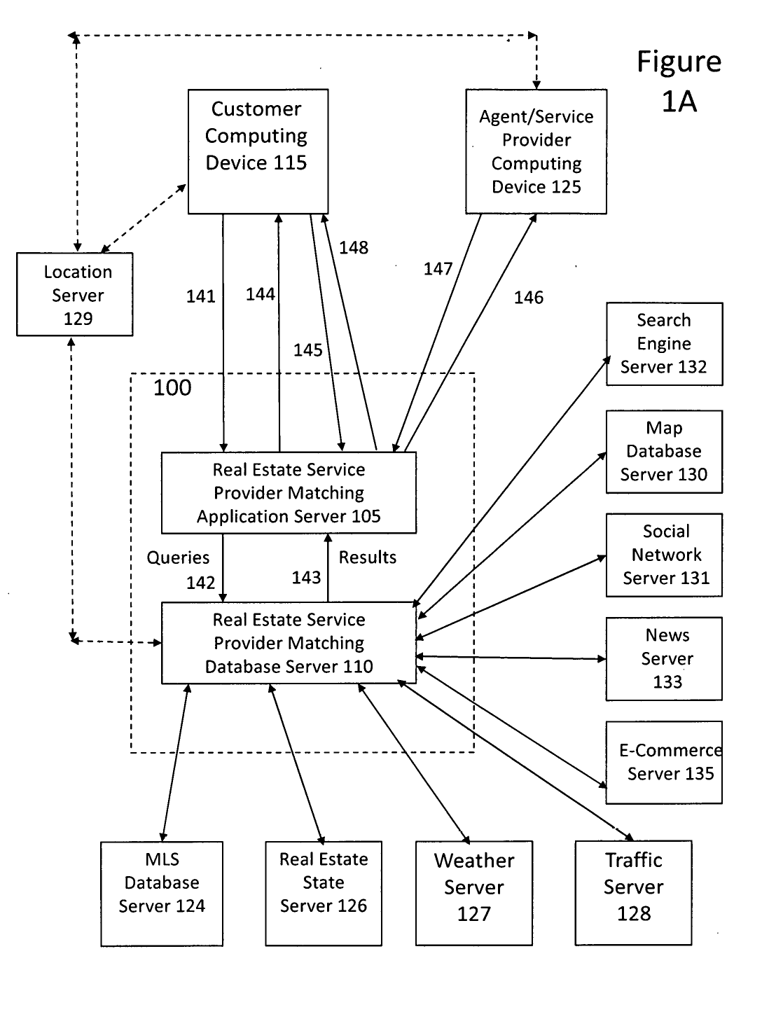

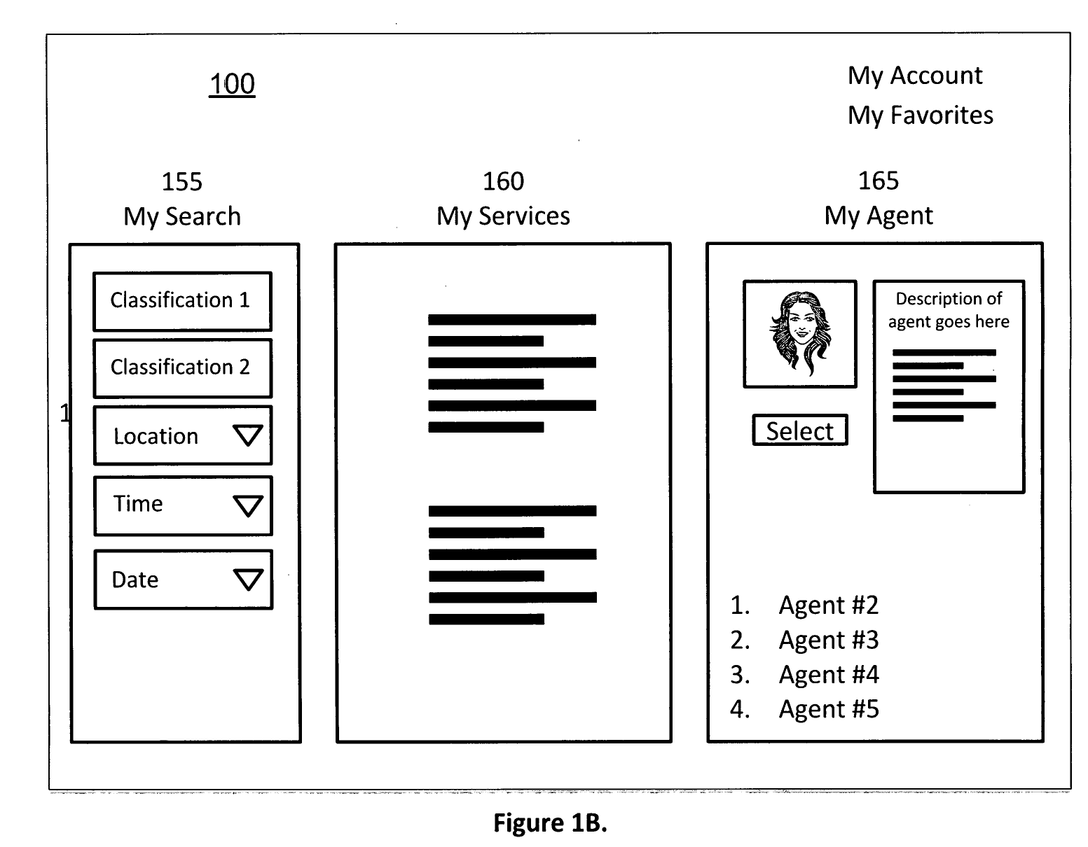

FIG. 1A illustrates a system architecture of a real estate service provider matching system according to embodiments. In embodiments, an on-demand real estate service provider matching (ODRESP) system 100 may comprise one or more service requester, buyer or customer computing devices 115, one or more service provider or agent computing devices 125, one or more on-demand real estate service provider matching application servers 105 and/or more on-demand real estate service provider matching database servers 110. In embodiments, an on-demand real estate service provider system 100 may interface with a number of external servers or computing devices. In embodiments, for example, an on-demand real estate service provider system 100 may communicate with and/or interface with a location server 129, which may provide location measurements and/or parameters of the one or more customer computing devices 115 and/or the one or more service provider or agent computing devices 125. In embodiments, the on-demand real estate service provider system 100 may communicate with one or more MLS database servers 124, one or more real estate state agency or licensing servers 126, one or more weather servers 127, one or more traffic condition servers 128, and/or one or more e-commerce servers 135. In embodiments, the on-demand real estate service provider system 100 may communicate with one or more news servers 133, one or more social network servers 131, one or more map database servers 130 and one or more search engine servers 132. In addition, there may be other or additional external servers and/or computing devices that update the ODRESP system 100. In embodiments, the external servers identified above may provide real-time updates or updates every one or two hours to the one or more ODRESP database servers 110. In embodiments, one or more requester or customer computing devices 115 may initiate a service request which may be transmitted or communicated 141 to the ODRESP application server 105. In embodiments, the one or more ODRESP application servers 105 may communicate the communicated service request query along with related parameters or measurements 142 to the one or more ODRESP database servers 110. In embodiments, in response to the application server's service request query, the one or more ODRESP database servers may generate query results (e.g., service providers who meet the requester criteria which may be expressed in terms of parameters or measurements) and may communicate and/or transmit 143 query results (e.g., a list of service providers) and associated parameters, measurements and/or information to the one or more ODRESP application servers 105. In embodiments, the ODRESP application servers 105 may communicate and/or transmit 144 the query results (and/or associated parameters, measurements and/or information) to the one or more customer computing devices 115. In embodiments, a customer or service requester may select one of the service providers communicated in the query results and may communicate 145 a service provider selection to the ODRESP application servers 105. Alternatively, only one service provider or agent may be recommended and the customer or service requester may select that one service provider. In embodiments, the selection happens automatically. In embodiments, the ODRESP application server 105 may communicate 146 a notification or selection message to the service provider computing device 125. In embodiments, a service provider or agent may accept the service request or meeting and communicate 147 an acceptance message (e.g., service request acceptance message) to the one or more ODRESP application servers 105. In embodiments, the ODRESP application servers 105 may communicate 148 a confirmation message to the client computing device 115 to confirm the meeting to perform the requested service and/or the event to complete the requested service. In embodiments, the messages described above are communicated or transmitted in real-time or within seconds in order to minimize time spent establishing and confirming the real estate transaction. In embodiments, the messages are communicated as soon as possible. In embodiments, a time length from submitting a service request (by a customer) to a service request confirmation message (from an agent or service provider) may be less than 30 seconds. In embodiments, a time length from submitting a service request to receiving a confirmation message may be less than a minute. In embodiments, a time length from submitting a service request to receiving a confirmation message may be less than 5 minutes. This is a significant improvement over existing real estate systems where delays may occur because a service provider or agent does not check emails, email servers don't transfer messages immediately, and/or a real estate server sends out a broadcast message which elicits many responses. Then, a customer has to navigate through this list in order to find an acceptable real estate agent, which consumes too much of a customer's time. The ODRESP system and real-time interaction is a computer-related improvement because the ODRESP system identifies recommended service providers immediately or as soon as possible (e.g., within less than 10 seconds in some circumstances and immediately communicates and immediately interacts with requester computing devices and/or provider computing devices (or interfaces as soon as possible) to confirm meeting times and/or selections.

In embodiments, a customer or real estate purchaser computing device 115 and/or an agent or service provider computing device 125 may use a software application that is capable of running on any current or future mobile computing device, desktop computing device, wearable computing device or laptop computing device or other computing device platforms. Thus, mobile phones, tablets, wearable glasses, iWatches and similar devices, desktop computers, network computers, laptop computer may be utilized to interface with the ODRESP software and/or system.

In embodiments, users, service requesters, service providers and/or agents may load the on-demand real estate service provider (ODRESP) software application onto the computing devices and may register, signup and create secure and password protected accounts within the ODRESP software application or ODRESP system. In embodiments, an account is created and relevant profile information may be entered for the user, customer, service requesters, service providers and/or agents. In embodiments, the information and/or parameters entered by the users, service requesters, service providers and/or agents may be utilized by the ODRESP software and/or ODRESP system to dynamically select service providers or agents (in real-time or within a short timeframe that match or closely align with criteria and/or parameters entered or previously supplied by the customers or service requesters).

In embodiments, depending on a persona, characteristics, preferences, identification and/or or job description of an individual (requester, customer, agent or provider) during registering, different profile information, parameters and/or measurements may be received and/or utilized. For example, in embodiments, real estate agents may be requested to enter a license #, a preferred housing listing profile (which may include a preferred geographic area, preferred price range, preferred home size, a preferred home style, a preferred home type (e.g., detached, duplex, condo) and other housing preference parameters,), that the real estate agent may service or prefer to service. In embodiments, an ODRESP software application and/or system may allow a real estate service requester or real estate service provider to edit and/or modify an input (or existing) preferred housing profile.

In embodiments, an ODRESP mobile computing device software application (i.e., running and being executed on a smartphone, a tablet, a wearable computing device, a laptop computing device, a desktop computing, etc.) may be utilized by the users and/or agents. In embodiments, the use of the ODRESP mobile computing device software application (in combination with the ODRESP server software and/or the ODRESP system) may make it possible to utilize location data (e.g., from location server 129s) and available map data (e.g., from map servers 130) to obtain and/or communicate real time or current status of any user, service requester, agent, and/or service provider to other ODRESP system users. In addition, the use of the ODRESP mobile computing device software application (in combination with the ODRESP server software and the ODRESP system) may communicate notifications or real-time notifications to the computing device of the users and/or agents. In embodiments, the ODRESP system's use of mobile computing device technology makes it possible to provide on-demand or immediate or as soon as possible matching of real estate product and service providers. In embodiments, the mobile computing device running and/or executing the ODRESP software may one or more processors, one or more memory device, computer-readable instructions stored in the one or more memory devices and executable by the one or more processors to perform functions and features described herein. In embodiments, the computing devices and/or mobile computing devices may further comprise one or more displays, one or more input/output devices, one or more location based sensors, one or GPS receivers, one or more WiFi transceivers, and/or one or more cellular service transceivers.

FIG. 1B illustrates a real estate agent service request screen or menu in an on-demand real estate service provider matching system according to embodiments. In embodiments, once a user or real estate customer is registered and/or has created an account, he/she can use the ODRESP software application. In embodiments, the ODRESP software application may allow a selection of a type of real estate service. In embodiments, depending on a type of real estate service selected, a user interface of the ODRESP software application may change visual menus to best display the kind of information, measurements or parameters that may be relevant for the type of selected real service in order for the user to include desired characteristics or preferences. For example, in embodiments, if the real estate user is interested in searching for available homes for sale, a user interface of the ODRESP software application may display attributes, classification search parameters, selection and search criteria that include parameters most relevant for that real estate service including, but not limited, to geographic location, price range, square footage, number of rooms, and number of bedrooms. In addition, the user may be able to select on other classifications, preferences or characteristics, including but not limited to, parks, proximity to cultural centers or events, availability of sports facilities, safety of neighborhood, proximity to businesses, etc. In embodiments, FIG. 1B illustrates an example search screen 155 where a user, requester or customer can enter the above-described parameters or criteria for a real estate agent search. Search screen 155 only displays a limited amount of criteria but the search screen 155 may be modified based on user input. In embodiments, search screen 155 includes as search criteria, property name or address or location of the real estate property, a time for a meeting with the real estate agent, a location of a meeting or performance of the selected service and/or a date of a meeting with the real estate agent. In embodiments, search screen 155 may include as search criteria real estate property classifications or neighborhood classifications related to the real-estate properties. These are described in detail above and below. When a user inputs these real-estate property classifications or neighborhood classifications, they may be referred to as preferences (e.g., user real estate property preferences or user neighborhood preferences).

In embodiments, as it pertains to real estate properties for sale, the ODRESP software application and/or system may be able to access a plurality of publicly available databases, either paid or free of charge, in order to select or identify a real estate asset or property. In embodiments, additionally, real estate agents may be able to list real estate properties for sale directly from within the ODRESP software application and/or system. In embodiments, the ODRESP software application and/or system may provide a real estate user or agent with an interface to allow for listing of a real estate property with details, including but not limited to square footage, location, price, landscaping details, neighborhood characteristics or parameters including business, restaurant, cultural or athletic characteristics or parameters. In embodiments, a listing for a real estate property may also include multimedia elements, including but not limited to can also be photos, videos, renderings and/or animations.

In embodiments, within the ODRESP software application and/or system, property listings created by real estate users may be proprietary and may reside or be stored within ODRESP database servers, which may or may not be publicly accessible. In embodiments, with the ODRESP software application, an application programming interface (API) may be created to allow other software applications (e.g., real estate software applications) access to all or part of the information, parameters and/or data related to the created real estate listing. In embodiments, the ODRESP software application may provide this access free of charge or for a fee.

In FIG. 1B, reference number 160 illustrates a services selection submenu of an ODRESP software application and/or system according to embodiments. In embodiments, a real estate user or service requester may select a desired real estate service via the services selection screen 160. In embodiments, after a real estate user selects the real estate product or real service he/she is most interested in and makes any selection refinements on parameters most relevant to that particular real estate product or service via the services selection submenu 160, computer-readable instructions executable by the one or more processors (e.g., the ODRESP software application in conjunction with the ODRESP system) may select and/or recommend one real estate agent (or real estate service provider) that may best be able to meet with the real estate user (or service requester) at a time requested (e.g., entered into the search submenu 155) and also meets a largest amount of search criteria, preferences or classifications of the user. In embodiments, the ODRESP software application and/or system may display a recommended real estate agent (or service provider) as well as additional real estate agents in a service provider list. In embodiments, the ODRESP software may rank the real estate agents (or service providers) by how close the real agents were to meeting the selection parameters or criteria, classifications and/or preferences of the user (as defined in the search screen 155).

In embodiments, reference number 165 illustrates a real estate agent submenu in the ODRESP software application and/or system where a listing of real estate agents (or service providers) is displayed to a real estate user, customer or service requester. In embodiments, the real estate agent (or service provider) submenu may allow a real estate user (or service requester) to affirm the recommended real estate agent (or service provider) (e.g., by pressing for example, a selection button). In embodiments, the ODRESP software application may also accept the input meeting time as a meeting time or may generate or select a meeting time based on agent (or service provider) availability and user (or service requester) submitted meeting time (e.g., try to find a time acceptable to both). In embodiments, a user (or service requester) may then choose to accept the meeting time with the agent (or service provider) selected by the ODRESP software application, or alternatively may override this meeting time selection. In embodiments, the OSRESP software application may also allow selection or choosing of another real estate agent (or real estate service provider) from the displayed list of agents (or service providers). In embodiments, the meeting time in the ODRESP software and system may default to immediate and/or as soon as possible. This is when a service requester (or real estate purchaser) wants to have contact immediately or as soon as possible with a service provider (or real estate agent). While in-person meetings may not be immediate, phone meetings or meetings via other communication tools may be close to immediate. This is a significant improvement over other existing systems because these systems do not have a way for a service requester (or real estate purchaser) to request and receive an immediate or as soon as possible meeting.

In embodiments, a real estate user (or service requester) may also save any real estate product or real estate service as a “favorite.” In embodiments, the ODRESP software application may save or stored this favorite in the ODRESP application server or ODRESP database server in a real estate user (or service provider) profile. In embodiments, having the favorite as part of a user profile, the ODRESP software application thus allows that real estate user quick access to the favorite real estate service or product again without having to re-enter or search for the favorite service in the service selection submenu 160. In embodiments, the ODRESP software and/or system may a user to edit favorite real estate products and services. In embodiments, the ODRESP software and ODRESP software system may allow edits or changes including, but not limited to renaming products or services, moving or adjusting an order of the products or services, deleting products or services, and/or sharing with other potential users favorite real state products or services via email, text, social media networks, and other communication technologies.

In embodiments, as discussed above, the ODRESP software application may select or choose, a recommended real estate agent for the real estate service selected or requested by the real estate user or requester by taking into account parameters, information, measurements and/or data, including but not limited to, the user selection criteria, real estate user and real estate agent preferences or classifications as defined in user and/or agent respective profiles, real estate agent availability, real estate geographic location (either at current time and/or during proposed meeting time), and environmental conditions such as weather and traffic (either at current time and/or during proposed meeting time). In embodiments, the ODRESP software application and/or system may execute an algorithm, and as a result, the ODRESP software application may determine, select and/or display a list of recommended real estate agents listed or ranked in order of which the recommended real estate agents may best be able to meet at a user requested time and place. In embodiments, for example, if the real user is looking for a home to buy and selects a particular home the user is interested in viewing or visiting immediately (e.g., within the next 15 or 30 minutes), the ODRESP software application and/or system may use the available parameters, information, measurements and/or data to determine, select and/or recommend at least one real estate agent that is able to meet with the real estate user within a shortest possible timeframe. As discussed previously, the ODRESP software application and/or system may default to an immediate or ASAP meeting time if a real estate service requester does not input a time. In addition, in embodiments, the ODRESP software application and/or system selects recommended service provider(s) (e.g., real estate agent(s)) in real time and/or ASAP, which is an improvement in computer-related technology.

In embodiments, the ODRESP software application may utilize GPS data (and/or other location measurements) and/or a geographical location of a selected meeting place (e.g., the house or real estate asset) in order to determine or calculate if the requested meeting time can be satisfied. In embodiments, the ODRESP software application and system may make this determination or calculation based, at least in part, an agent's distance from the geographic location, traffic conditions between the geographic location and the agent's location, weather conditions in the area, and known driving patterns and/or routes. If the meeting is not possible to meet based on the conditions described above, the ODRESP software application may communicate another meeting time to the real estate user computing device to display to the user. In embodiments, the ODRESP software application may communicate updates on status to the real estate user computing device as well as providing an estimated time of arrival as well as other alerts of traffic issues or weather issues. In embodiments, the ODRESP software application and system may continuously and/or periodically update status of the real estate agent (e.g., service provider) knowing that different parameters and/or environmental conditions may change. All of these features are improvements in computer-related technology because the ODRESP system is being updated continuously with information, parameters and measurements from external servers/computing devices; utilizing artificial intelligence to make service provider recommendations and communicating with provider and requester computing devices in real-time and receiving real-time updates and/or information, parameters and measurements from these computing devices.

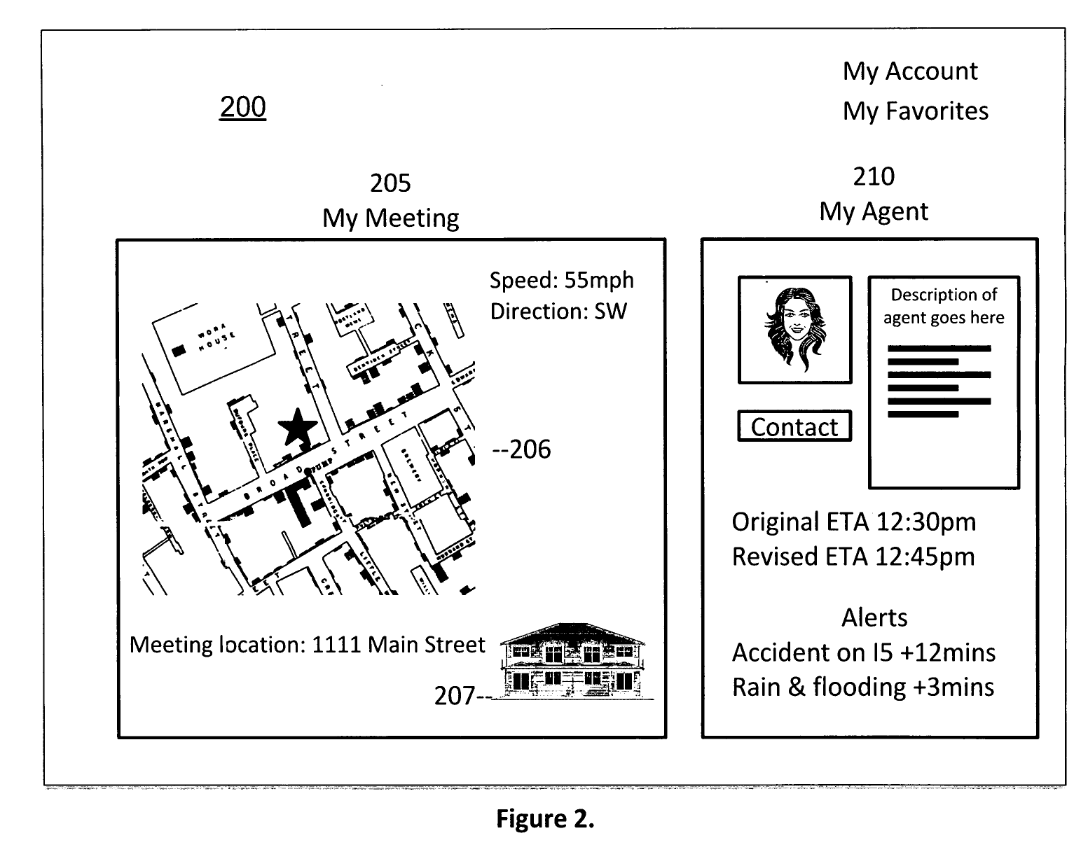

FIG. 2 illustrates a service request confirmation screen according to embodiments. FIG. 2 illustrates a service request confirmation screen 200 in an ODRESP software application comprising a meeting update submenu 205 and an agent update submenu 210. In embodiments, the ODRESP software application agent update submenu 210 may display information or data about that real estate agent or service provider that is pertinent to the real estate property (or service) that is to be visited or provided. In embodiments, ODRESP software application agent update submenu 210 may include, but not be limited to, the following information for a real estate agent: a photo image, age information, professional license number information, years of experience information, other real estate services offered, current location measurements, name of real estate company the selected real estate service provider represents, and/or rating values. For example, in embodiments the real estate user or customer may be looking for a home or real estate property to purchase and may be requesting to view that home, and the ODRESP software application and/or system may generate and display a listing of real estate agents and associated information and/or parameters. In embodiments, a real estate purchaser may select one or the recommended real estate agents and the ODRESP software application and/or system may provide parameters, measurements and information with respect to the recommended real estate agent (e.g., the agent picture, real estate company the agent works for, agent real estate license, agent years of experience, real estate current location measurements, and/or estimated time to reach the meeting point) in the agent update submenu 210 and communicate that information to the user or customer computing device.

In embodiments, the ODRESP software application and system may calculate and/or generate the estimated time of arrival (ETA) for a real estate agent to reach a requested meeting location and the ODRESP software application may take into account information, measurements, data and/or parameters including, but not limited to distance measurements, traffic data, weather conditions or parameters, and known driving patterns. In embodiments, the ODRESP software application and/or system may be updated in real time as any information, measurements, data and/or parameters used to calculate the ETA changes. In embodiments, the ODRESP software application and system may continually refresh or periodically refresh the displayed information at an interval that will be set within the ODRESP software application and system. In embodiments, the ETA may be displayed in the agent update submenu 210.

In embodiments, the ODRESP software application may allow real estate users to select a real estate agent from the real estate list generated by the ODRESP software application, and in response to selection of the real estate agent, the ODRESP software application and system may notify the real estate agent via a preferred method defined in the real estate agent's account profile. In embodiments, these notifications may be occur in real-time and/or immediately. In embodiments, the ODRESP software application may generate the notifications and/or messages via currently available messaging methodology including, but not limited to, SMS messaging, MMS messaging, other forms of instant messaging, automated phone calls, and social networks messaging. In embodiments, the ODRESP software application and system may allow a real estate agent a limited amount of time to accept or reject the meeting request. In embodiments, the real estate agent's method of notification may be email. In embodiments, the ODRESP software application and/or system may allow a limited amount of time (e.g., 5 minutes to 30 minutes to accept the request). In embodiments, and system if the real estate agent accepts the real estate user request, the ODRESP software application may send a confirmation notification message to the real estate user via a preferred communication method defined in the real estate user's account profile. In embodiments, the confirmation notification message may include information, measurements and/or parameters about the selected real estate agent including, but not limited to a photo image, contact information, and estimated time of arrival value or measurement.

In embodiments, if the real estate agent does not accept the service request within an allotted time, the ODRESP software application and system may generate a notification message to notify the real estate user computing device and may also communicate or recommunicate a list of recommended real estate agents from the generated list. In other words, if the real estate agent rejects the service or meeting request, the real estate user may be notified and may be presented with a next best available option from the list of real estate agents. In embodiments, the real estate agent must enter a reason for rejecting the request. In other words, the ODRESP software application and system may request and/or require reasons for rejecting service or meeting requests and may store the entered rejection reasons. In embodiments, the ODRESP software application and system may allow for these rejections to be reviewed by managers or the software application itself may automatically analyze the rejection reasons.

In embodiments, the ODRESP software application and system may allow real estate users to communicate directly to selected potential real estate agents. In embodiments, the ODRESP software application may provide functionality to allow real estate users and selected real estate agents to communicate via online methods such as online chat, computer telephone calls and/or video conference.

In embodiments, the ODRESP software application and system may provide a real estate user and a real estate agent with real time, turn-by-turn driving directions from within the ODRESP application. In embodiments, in order to provide this service, the ODRESP software application and system may utilize any currently available online mapping software applications, such as Google Maps or Waze. In embodiments, the driving directions may be displayed from within the ODRESP software application and system in order to provide the real estate user and real estate agent with a cohesive user experience and may also eliminate a need for ODRESP software application users to exit the ODRESP software application and use another third-party software application. In embodiments, the ODRESP software application may provide this information and location information in meeting detail or display submenu 205.

In embodiments, the ODRESP software application and system may display a real-time status in terms of location of where a real estate agent is from the agreed-upon meeting. Thus, from within the ODRESP software application, the real estate user may see real time status of where the real estate agent is located in the meeting display submenu 205. In embodiments, a real estate agent's location may be overlaid on a map 206 displayed on a real estate user's computing device in the meeting detail or display submenu 205 may adjust their arrival times or other plants to meet their needs. In embodiments, the ODRESP software application and system may also display other status information, such as real estate agent's estimated time of arrival, real estate agent's current location 206, and/or real estate agent vehicle's speed in the meeting detail or display submenu 205. In embodiments, the meeting detail or display submenu 205 may include a map 206 and/or an image including the meeting location or the real estate property 207.

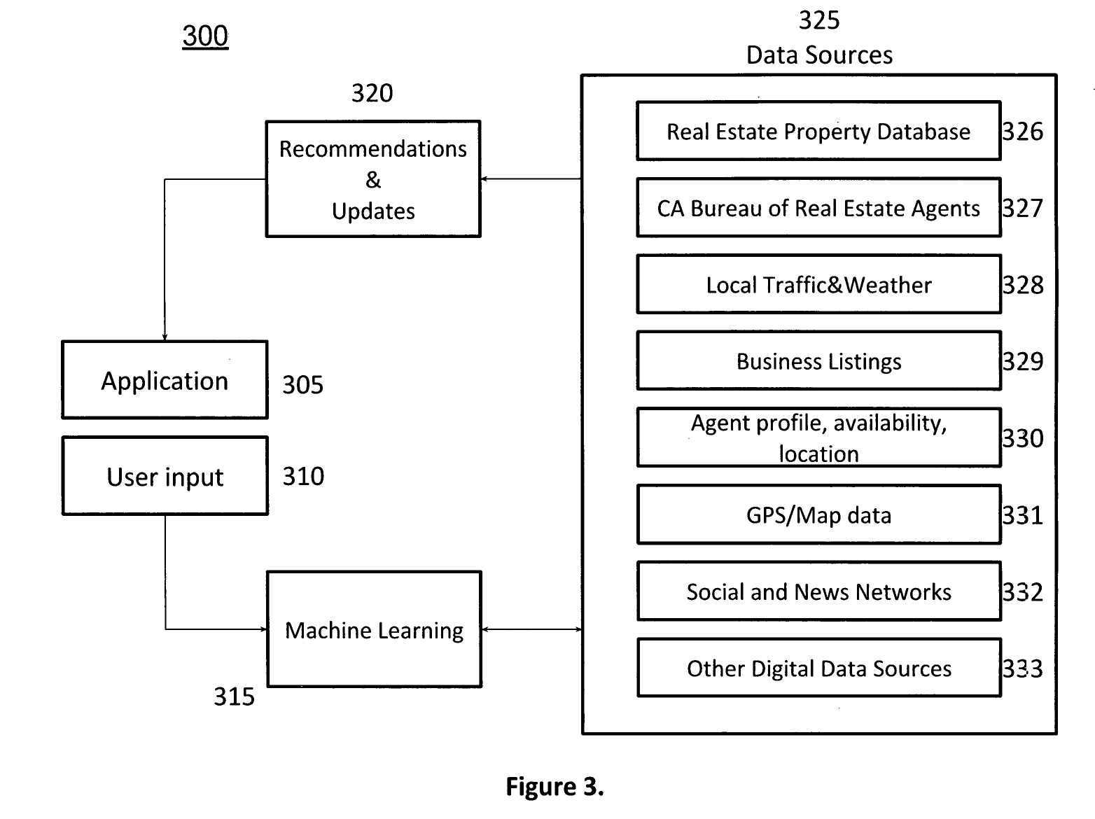

FIG. 3 illustrates a block diagram of a system for estimating a real estate agent's or service provider's status and/or location according to embodiments. In embodiments, the ODRESP software application may utilize a number of factors and/or data sources in determining and calculating a status of the real estate agent, an ETA of the real estate agent with respect to a proposed meeting location and/or a current location of the real estate agent en route to the proposed meeting location. This is unique from other real-estate systems because the ODRESP software application or system immediately or quickly matches agents and buyers, quickly or immediately sets up meetings at available real estate properties and provides real-time status information for the real estate agent who has accepted a meeting request to reduce the amount of waiting time and/or wasted time in real estate property transactions. This is a significant advantage for users and agents engaged in real estate transactions. In embodiments, the ODRESP software application may automatically initially display a real estate agent's status in the meeting display submenu 205 and the agent update submenu 210 based at least in part on the real estate agent's geographic location and real time data associated with the real estate agent after an agent has been selected by a user. In embodiments, the ODRESP software application and system may also automatically change a real estate agent's status in the meeting display submenu 205 and an agent update submenu 210 depending on a real estate agent's geographic location and real time data associated with the real estate agent. In other words, the ODRESP software application may change a real estate agent's location on a map 206 displayed in a meeting display submenu, as shown in FIG. 2, or may update an agent's status or ETA in an agent update submenu 210.

The ODRESP software application and system may query one or more ODRESP database servers to obtain original parameters, measurements and/or information, or similarly, to obtain updated parameters, measurements and/or information associated with the real estate agent's location and/or status. The discussion below, with respect to FIG. 3, applies to both the retrieval of original parameters, measurements and/or information and the retrieval of updated parameters, measurements and/or information. In embodiments, as illustrated in FIG. 3, an ODRESP software application 305 may request recommendations (e.g., utilizing the original parameters, measurements and/or information) or updates through, for example, a recommendations or updates module or subroutine 320. In embodiments, the request may be a query which communicates with one or more ODRESP database servers (e.g., 325 in FIG. 3) to obtain the original or updated real estate agent parameters, measurements and/or information. As is illustrated in FIG. 3, the one or more ODRESP database servers 325 may comprise an MLS Database module 326 (which receives MLS listing information and associated parameters from an MLS server); a California Bureau of Real Estate Agents module 327 (which receives licensing information, complaint or feedback information and/or other related parameters from a real estate licensing board server); a local traffic and weather module 328 (which receives weather measurements and/or information from online weather provider servers and traffic measurements, parameters and information from online traffic information servers); a business listing module 329 (which receives local business listings and other business-related measurements, parameters and information from local business servers); an agent profile, location and availability module 330 (which has information about a real estate agent's current location, present or future availability and other personal characteristics or parameters of the real estate agent); a GPS and map data module 331 (which receives mobile device measurements from the real estate agents computing device as well as customer or user's computing devices in addition to receiving measurements, parameters, and information from online map servers); other digital data sources relative to real estate properties and/or real estate service providers 333 (which receives measurements, parameters and information from other digital data sources); and/or social network and/or news network servers 332 (which receives parameters, measurements and/or information from online news servers and/or social network (Twitter, Instagram, Facebook) servers.

In embodiments, portions of the ODRESP database server may be utilized to provide an updated real estate agent location, status and/or estimated time of arrival. In embodiments, portions of the ODRESP database server 325 may be utilized to provide updated real estate information and/or parameters such as license status and/or status in social networks.

In embodiments, an ODRESP software application and system may utilize a sensor data to determine an initial location or to generate an updated location of the real estate agent. In embodiments, for example, a real estate agent's mobile device may obtain GPS data utilizing a GPS receiver and/or may obtain WiFi location data utilizing the WiFi transceiver and may communicate the GPS location measurements and/or WiFi location measurements to GPS data modules 331 and/or map data modules 332 in the one or more ODRESP database servers 325. In embodiments, a user's vehicle and/or a user's mobile device may report vehicle speed to one of the modules of the one or more ODRESP database servers. In embodiments, the ODRESP software application and/or system may query the one or more ODRESP database servers to obtain the WiFi measurements and/or GPS measurements and utilize these as well as the speed measurements to assist in calculating the real-time location of the real estate agent as well as a real estate agents ETA. In embodiments, a GPS/map data server 331 and/or the local traffic/weather server 328 may also receive updates on road closures due to special events, accidents, traffic situations, and/or road closures. In embodiments, the ODRESP software application 305 may utilize these parameters, measurements and/or information in determining the real time location on the map displayed in the meeting display submenu as well as the ETA displayed in agent update submenu 210 and/or the meeting update or detail submenu 205. In embodiments, the ODRESP software application may also query the local weather and traffic module 328 in the one or more ODRESP database servers to identify if there are any weather issues in the area near the meeting location and/or en route to the meeting location. In embodiments, the ODRESP software application 305 may utilize the retrieved weather parameters in calculating or determining the real estate agent's ETA and/or current location and presenting the ETA in the agent update submenu 210 and/or the meeting update or detail submenu 205. In embodiments, for example, when the real estate agent arrives at the destination (e.g., the meeting place), the ODRESP software application may query the ODRESP database server 325 to obtain can use geographic measurements and/or data at a to verify the real estate agent's location is the same as the meeting place location and if verified, the ODRESP software may automatically change a real estate agent's status in either or both of the agent update submenu 210 and the meeting display submenu 205. In embodiments, a real estate agent may also change his/her status by providing user input 310 to the ODRESP software application. In embodiments, the ODRESP software application may generate a notification and communicate the notification to the user computing device if the real estate agent's status changes. In embodiments, the ODRESP software application may also utilize the techniques described above in updating the real-estate agent's location, status and/or ETA. In embodiments, the ODRESP software application may generate occasional notifications to provide a user computing device with updates regarding real estate agent location and how much longer before the user arrives at the meeting point. In embodiments, the ODRESP software application and system may allow the user with an option to disable this updating feature.

In embodiments, the ODRESP database server 325 may be utilized with a machine learning or deep learning module 315 to assist in generating recommended real estate agents. In embodiments, a machine learning or deep learning module 315 may be computer-readable instructions stored in one or more memory devices of an ODRESP application server which are executable by one or more processors to analyze data retrieved from one or more of the modules of the ODRESP database server 325 and to generate recommended real estate agents for a real estate user. In embodiments, this software may be referred to as machine learning or deep learning because the software is able to extract patterns from the received measurements, parameters and information from the modules in the ODRESP database server 325 and group together different parts of the parameters, measurements and/or information to form an optimal recommendation for a real estate agent and/or service provider. In embodiments, for example, the ODRESP application software may retrieve parameters and/or information from the CA real estate module 327 in order to obtain accurate and up-to-date information on real estate license status, fines paid, complaints received and what types of real estate licenses each registered real estate agent has. In embodiments, for example, the ODRESP application software may retrieved parameters, measurements or information from an MLS module 326 including but not limited to property parameters, selling prices, locations, listing agents, sellers. In addition, the MLS module 326 may also include any lien or security interest that may have been placed on the property. In embodiments, the social network and news network module 333 may receive parameters, measurements, information and/or data related to real estate agents, real estate properties and/or real estate purchasers from the social network servers and/or online new servers. In embodiments, parameters may include comments made by real estate agents on social media platforms, events held or that occurred at real estate properties, numbers of sales and locations of sales and pictures of real estate sales made by real estate agents. In embodiments, a machine learning or deep learning module 315 in the ODRESP software application may query for information, parameters or measurements from the social network and news network database servers 333, analyze the received information, parameters or measurements related to relevant real estate agents to spot trends or important information, and provide results of analyzation to a recommendation and update module 320 of the ODRESP software application. In embodiments, the ODRESP software application may utilize the provided results in selecting a recommended real estate agent. For example, in embodiments, the machine learning or deep learning module 315 may identify that a certain real estate agent has sold three houses in a certain gated neighborhood, received positive postings regarding the sales on social media and the real estate user is looking for a property in that specific gated neighborhood based on analyzing the information, parameters or measurements in the various modules of the database server 325. In response, the machine learning or deep learning module 315 may provide this information to the recommendation and update module 320 along with a weighting factor to identify that this real estate agent should be recommended (or at least put in the recommended list) because of these unique positive characteristics. As another illustrative embodiments, a machine learning or deep learning module 315 may identify that a certain real estate agent, by extracting relevant data from information provided by the online news module 333, is going through a divorce and has been convicted of drunk driving within the last two weeks. In embodiments, the machine learning of deep leaning module 315 may provide this information to the recommendation or update module 320 of the ODRESP software application in order to reduce a rating of a real estate agent and prevent the real estate agent from being selected as a recommended agent or being on the list of recommended agents, although the agent may be available and may have other positive characteristics (e.g., handles these types of houses and/or lives in the geographic area). This is a significant advantage of the subject matter described herein over prior systems in that the ODRESP software reviews outside information normally not utilized in pairing real estate sellers and agents in a timely matter, looks at a variety of factors and is able to automatically recommend a real estate agent that best fits all the needs of real estate purchaser.

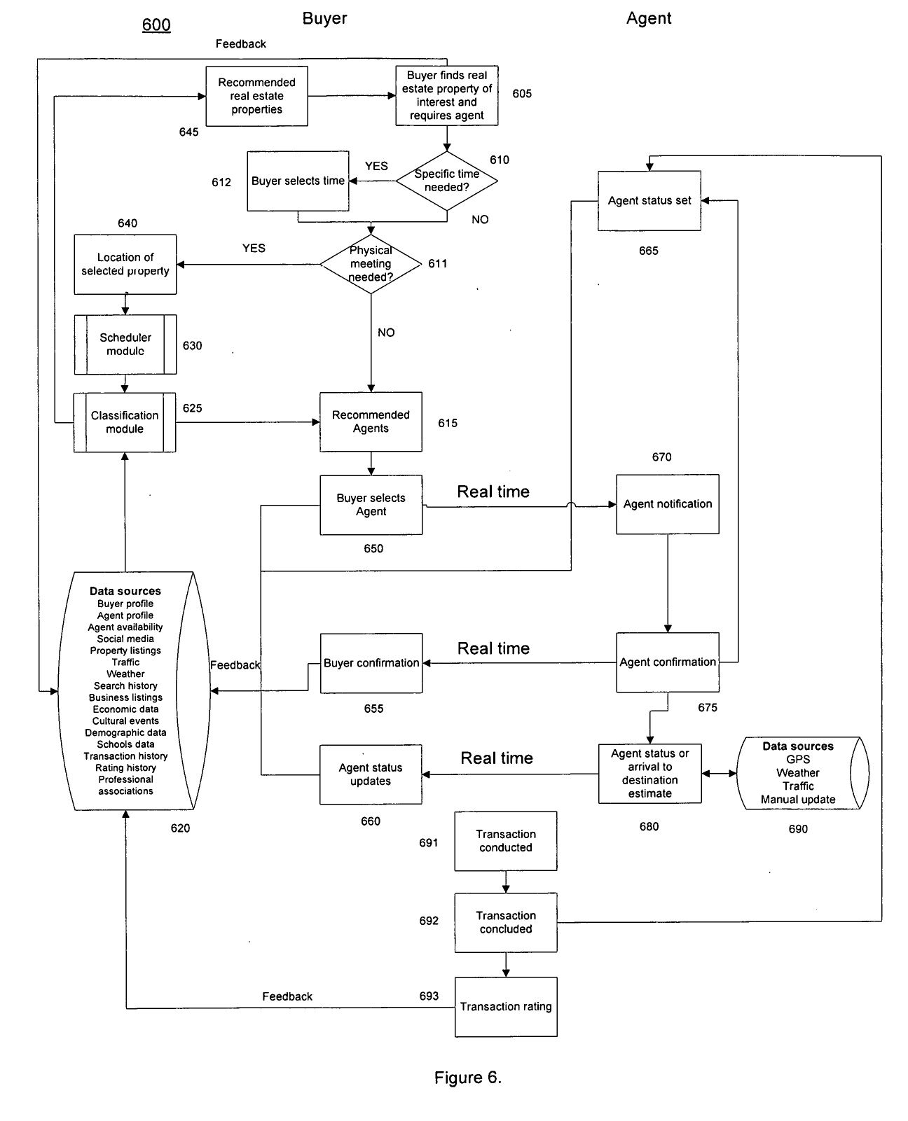

FIG. 6 illustrates a flowchart of an on-demand real estate service provider matching process according to embodiments. Described herein are meant to be illustrative examples rather than be limiting with respect to claimed subject matter. Likewise, an embodiment may be simplified to illustrate aspects and/or features in a manner that is intended to not confuse and/or hide claimed subject matter through specificity and/or details. Embodiments in accordance with claimed subject matter may include all of, less than all, or more than blocks 600-693. In embodiments, the order of blocks 600-693 may merely be an illustrative order and other orders may be possible.

In embodiments, computer-readable instructions executable by one or more processors or microcontrollers may perform the process described below. In embodiments, the computer-readable instructions may be executable by one or more processors on a mobile computing device (e.g., a smartphone, a tablet, a wearable computing device, etc.), a server computing device, a desktop computing device or a laptop computing device, or a combination thereof. In embodiments, in other words, the ODRESP application software may be resident on a mobile computing device, a server computing device, or a desktop computing device, or a combination thereof. In embodiments, a graphical user interface or menu may be presented on a monitor of one of the computing devices discussed above, to allow a user or operator to select items to be executed or steps to be executed. In embodiments, a computing device may comprise voice recognition software to allow a user or operator to select actions and/or options to be performed via voice commands. In embodiments, as discussed above, the software may be referred to as an on-demand real estate service provider (ODRESP) software, ODRESP application software, an ODRESP system, or other similar terms.

In embodiments, in step 605, a buyer or real estate service requester may select a real estate product or a real estate service. In embodiments, it is important to identify when a service needs to be performed or product is of interest. In FIG. 6, for example, a buyer and/or customer may find a real estate property of interest. In embodiments, a buyer or customer may then need a real estate agent.

In embodiments, in step 610, a real estate buyer may determine if a specific time is needed to meet a real estate agent. One significant advantage of the ODRESP system is the ability to quickly meet a real estate agent and to get a real-time response (or a very quick response). In embodiments, if a specific time is not input, the ODRESP system may default to an immediate meeting and/or a meeting as soon as possible.

In embodiments, if a specific time is needed, a real estate buyer may select a time 612 to meet a real estate agent. In embodiments, this meeting may be in person, over a video conference, over a chat line or over a mobile telephone. In embodiments, this allows a real estate buyer to select a time (e.g., 30 minutes from now, an hour or two from present time) or a precise time in the future to meet the real estate agent. Again, this is a significant advantage over present day systems where there is no specific time input for meetings with real estate agents.

In embodiments, a real estate buyer may select to have a physical meeting or in person meeting 611. In embodiments, this means that the real estate agent would agree to meet the real estate buyer at the selected or recommended real estate property 640. In embodiments, geographical coordinates (e.g., street address, latitude and longitude, track number) may be utilized to identify the real estate property.

In embodiments, if no in person meeting is necessary, in step 615, computer-readable instructions executed by the one or more computing devices may select and/or recommend one or more real estate agents based on a variety of factors discussed below. In embodiments, artificial intelligence and deep learning are utilized to analyze data from external and internal data sources to recommend the one or more real estate agents. This is an advantage of the claimed subject matter in that the on-demand real estate service provider matching (ODRESP) system utilizes a variety of factors to quickly determine and/or identify the recommended real estate agents. In embodiments, as shown in step 620, for example, the ODRESP system may utilize external or internal data sources to make this recommendation, such as, but not limited to, a real estate agent profile, a real estate buyer profile, social media profiles and/or social media usage data, a real estate agent's digital footprint, (e.g., other online sources besides social media platforms), property listings, traffic information, weather information, real estate agent's or buyer's search histories or search profiles; neighborhood business listings, neighborhood economic data, neighborhood cultural events or information or parameters, neighborhood or property demographic data, neighborhood or property schools or education information, real estate trends or trending information; real estate agent transaction histories; real estate agent rating values, real estate agent rating value and/or real estate agent professional associations information or data. In embodiments, the ODRESP system may utilize the classification module 625 to generate a plurality of classifications for the information, data and parameters described above. In embodiments, these classifications may be, for example, entertainment classifications, recreation classifications, educational classifications, food parameters, industry type classifications, retail or commerce classifications, and/or traffic or weather classifications. In embodiments, the ODRESP system classification module 625 may utilize generate home design-related classifications based at least in part on architectural style parameters, landscaping style parameters, plant style parameters, outdoor living parameters, interior design parameters, interior layout parameters, kitchen style parameters, bathroom style parameters, family style parameters, entertainment style parameters, home theatre style parameters, and/or pool/sauna/jacuzzi style parameters. These are illustrative classifications and others may be utilized. This is another significant advantage over present systems because the classifications described herein are not utilized to determine and/or recommend real estate agents. In embodiments, these classifications may be real estate property classifications and/or neighborhood classifications.

In embodiments, an ODRESP system may store relevant parameters, measurements, value and/or data in one or more ODRESP database servers. In embodiments, in step 620, one or more data sources may provide and/or store data, measurements, and/or profile values in one or more database servers or other computing devices. In embodiments, for example, social media platform database servers and social media platform application servers may update the ODRESP servers with information regarding one or more real estate agents and/or one or more real estate buyers. In embodiments, for example, real estate listing services database servers and real estate listing application servers may update the ODRESP database servers with information regarding one or more real estate agents; and/or one or more real estate buyers. In embodiments, for example, finance (e.g., banks, insurance, credit unions) database servers and finance application servers may update the real estate agent matching database servers with information regarding one or more real estate agents; one or more real estate agents and/or one or more real estate buyer.

In embodiments, in step 625, computer-readable instructions (software) may be executable by one or more processors of the computing devices (e.g., the ODRESP software classification module) may create the real estate property classifications and neighborhood classifications described above and communicate this to the recommendation module 615. In embodiments, a recommendation module of the ODRESP software and/or ODRESP system may perform artificial intelligence and/or machine learning and utilize the received home and/or neighborhood classifications received from the classification module 625 to generate one or more recommended real estate users that meet the real estate buyer criteria (e.g., sell real estate properties like the property requested by the real estate buyer and that can meet the real estate buyer's time preference. In embodiments, for example, the buyer may be looking to purchase a real estate property in southern Orange County and may request to have a call with a real estate agent at 7:00 pm. In embodiments, the recommendation module 615 of the ODRESP software and/or system may utilize artificial intelligence and/or machine learning to generate a list of recommended real estate agents that have classifications that meet the real estate buyer's preferences or input. For example, the recommendation module may search for real agents that 1) sell properties in the requested area; 2) have a positive rating; 3) have sold two or more homes in Orange County; 4) have an active social media presence, and 5) are available for a phone meeting at the requested time. In embodiments, based on the artificial intelligence and/or machine learning, computer-readable instructions may executable by one or more processors on one or more computing devices (e.g., the recommendation module 615 of the ODRESP software and/or system) may generate one or more real estate agents and present the one or more recommended real estate agents to the customer or client as recommended options. Again, this is a huge advantage in processing speed of real estate agent matching systems.

In embodiments, the real estate buyer may request a physical meeting with the real estate agent. This provides an additional variable of having to find one or more recommended real estate agents that are able meet at the real estate property. Thus, other classifications may need to be utilized by the ODRESP recommendation module 615 in order to recommend one or more real estate agents. In embodiments, a location of the selected real estate property 650 is input into a scheduler module 630. In embodiments, a scheduler module 630 may be receive as input real estate agent's availability and also the real estate buyer's schedule. In embodiments, the scheduler module 630 may provide this input to the classification module 625 and/or also the recommendation module 615 so that the recommendation may select one or more real estate agents that are able to meet at the real estate property location, at or around the selected time and/or have favorable or similar classifications with respect to the real estate property buyer.

In embodiments, in step 650, a real estate buyer may select a real estate agent from the list of real estate agents (or the one or more recommended real estate agents). In embodiments, the computer-readable instructions may be executable by one or more processors on a computing device (e.g., the ODRESP software system) may provide and/or display one or more recommended real estate agents that most closely matches (e.g., has classifications values that match) the searching criteria input by a user. In embodiments, the ODRESP software and/or system may display more than the recommended real estate agent's names (e.g., some of the classification values may be displayed, as well as contact information, geographic region of service, number of houses sold in last 30 days, types of houses sold in last 30 days and/or any of the other parameters, measurements and/or information relevant to the real estate user.

In embodiments, in step 670, the computer-readable instructions executable by one or more processors of a computing device (the ODRESP software and/or system) may communicate in real-time or within a few seconds a selected notification to a real-estate agent. In embodiments, for example, this may occur utilizing SMS messaging or other notification services that are transmitted out or pushed out from the customer computing device immediately after a real estate agent selection has been made. In embodiments, the selected real estate agent may confirm or accept the real estate customer selection and the real estate service agent computing device may communicate 675 a confirmation notification or message to the real estate buyer computing device in real-time or within a few seconds after confirmation has occurred. In embodiments, this provides a real estate customer with immediate or close to immediate confirmation that the selected real-estate agent may meet them at a location to view a property. For example, this may occur within seconds, within minutes or even 30 minutes. This is a significant improvement as to existing systems or software for matching real estate agents and/or real estate buyers, where emails are sent to a number of real estate agents and the real estate agents may respond at a later time at their convenience. The subject matter described herein provides the customer with immediate feedback and reduces the amount of time spent communicating back and forth to set up a meeting or viewing of a potential real estate asset. In alternative embodiments, the ODRESP software and system may communicate a customer meeting request to a number of real estate agent computing devices in real time. In this alternative embodiment, the agent and real estate computing device that responds to the meeting request the quickest and also meets a number of other specified criteria (e.g., neighborhood expertise and/or home style expertise) may be assigned or referred to the real estate property buyer.

In embodiments, in step 650, the computer-readable instructions executable by one or more processors of a customer computing device (e.g., the ODRESP software and/or system) may receive the real estate agent confirmation notification and may generate a real estate buyer confirmation message or notification, which may be communicated 655 in real time or within a few seconds to the real estate computing device. In embodiments, a real estate buyer computing device may also send a feedback message and/or notification to the one or more database servers to update different records and/or parameters or information regarding the real estate buyer and/or the real estate provider.

In embodiments, another feature of the ODRESP software and/or system is an ability to track a real estate agent) as a meeting or event approaches and to provide status updates and/or notifications to a real estate buyer. In embodiments, the ODRESP software and/or system may determine 680 a status of the real estate agent by communicating with external servers or computing devices, analyzing the received information and then calculating and/or determining the real estate agent's status. In embodiments, external servers or computing devices may comprise GPS receivers or GPS measurement devices on real estate agent computing devices or nearby computing devices, weather servers or computing devices, and/or traffic servers or computing devices 690). In embodiments, the ODRESP system and/or software may periodically communicate with the external servers 690 (as described above) to obtain parameters, data, measurements and/or information. In embodiments, the ODRESP system and/or software may communicate in real-time with the external servers or computing devices at specified times before meeting times or events are to begin in order to provide the real estate buyer with real-time or immediate status updates of the real-estate agent. In embodiments, in step 660, the ODRESP software of the customer computing device may receive the real estate agent status notification and thus be aware, in real-time of the location and/or arrival time of the real estate agent and plan accordingly.

In embodiments, in step 675, computer-readable instructions executable by the one or more processors of the real estate agent computing device may generate 660 a status notification for a real estate agent at specified timeframes before a meeting or event is scheduled to occur and may communicate this information to the real estate buyer computing device (where it is displayed in the ODRESP software). In embodiments, the real estate agent computing device may periodically generate a status notification (e.g., on the road, in heavy traffic, getting fuel) along with associated status parameters (e.g., how many miles or minutes a real estate agent is away from the event or meeting) and periodically communicate the generated status notification 660 to the customer computing device utilizing the ODRESP software and/or system.

In embodiments, in step 691, the meeting and/or event between the real estate buyer and the real estate agent may be conducted. In embodiments, in step 692, the meeting and/or event between the real estate buyer and the real estate agent may be concluded. In embodiments, the real estate agent may update its status to available in the ODRESP software and/or system since the meeting, event and/or transaction may be concluded. In embodiments, the ODRESP software application on the real estate agent may communicate 665 the updated status to the ODRESP system and/or software. In embodiments, a real estate buyer may determine 693 a rating for the real estate agent. In embodiments, in step 693, the ODRESP software and/or system on the real estate customer computing device may communicate 620 the real estate agent rating for the meeting, event or transaction to the ODRESP system (e.g., the ODRESP application servers or the ODRESP database servers). In embodiments, the customer's real estate agent rating may also be utilized to update a real estate agent's transaction history, a ratings history, and/or a real estate agent's profile, among other characteristics, in the ODRESP database servers and/or application servers 620.

In embodiments, the ODRESP software application or system may include a rating feature to allow real estate customers to rate real estate agents and leave comments in addition to the ratings. In embodiments, the ODRESP software application may automatically calculate real estate agent ratings based on any available professional ratings, other publicly available sources including comments regarding the real estate agent and/or ratings supplied by users or the ODRESP software application. In embodiments, the ODRESP software application may display these ratings in one or more of the menus of the ODRESP software application. In embodiments, the managers of the ODRESP software application may choose to temporarily or permanently ban a real estate agent from using the ODRESP software application if the agent's ratings are below an acceptable level or threshold level (the ODRESP software may automatically ban real estate agents once if a rating level dips below a threshold level).

In embodiments, the ODRESP system and/or software may automatically gather data, measurements, parameters and/or information for homes and/or neighborhoods from a number of external sources; automatically and potentially without human intervention, analyze the received data, measurements, parameters and/or information and generate a number of real estate classifications based on the analyzation and store the data, measurements, parameters and/or information in one or more memory devices of the ODRESP application servers and/or database servers. In embodiments, the ODRESP system software may automatically make recommendations for real estate products or services based at least in part on the data, measurements, parameters and/or information in the one or more generated classifications for the homes and/or neighborhoods. In embodiments, the ODRESP system and/or ODRESP software may make recommendations for real estate products or services automatically without any user invention. In embodiments, this may occur by the ODRESP system and/or software utilizing the user's profile and preferences and comparing this against the classifications generated by the classification module to determine real estate properties 645 that are recommended for the real estate buyer. In other words, once a real estate user has registered or created an account in the ODRESP software and/or system, the ODRESP software and/or system may generate 645 one or more recommended real estate properties for the real estate user automatically without user input. In alternative embodiments, the ODRESP software and/or system may present a real estate property buyer user with an input screen allowing the real estate buyer to input selection criteria for a requested real estate property. In embodiments, the selection criteria may include the classifications previously generated by the ODRESP system and/or software as well as existing home searchable classifications such as home size, number of bedrooms, square footage, and/or zip code, which sometimes may be referred to as “hard data.”

In embodiments, external data sources may include, but are not limited to traffic servers or computing devices, weather or almanac servers or computing devices, city planning servers or computing devices (which could include urban development plans, zoning parameters and other relate information), governmental safety servicers or computing devices (e.g., police, fire and/or other emergency services servers to provide police reports, crime statistics, file statistics), educational information servers or computing devices (e.g., to provide availability of education (grade, middle and high school —public and private; universities, colleges, vocational schools, libraries); news servers or computing devices (including newspapers and/or televisions or online news providers); business and commerce servers or computing devices (which could include types of businesses, types of restaurants, types of consumer shops, types of industries, etc.); entertainment servers or computing devices (including but not limited to movie chain servers or computing devices; restaurant, bar or dining servers or computing devices; cultural event servers or computing devices; museum servers or computing devices); recreational activity servers or computing devices (including but not limited to city and county recreational activities; professional, high school and college recreational activities); search engine computing devices or servers; and/or social network computing devices or servers; chat servers or computing devices; and/or online forum servers or computing devices; service providers servers and/or computing devices; and/or other real estate-based servers or computing devices.

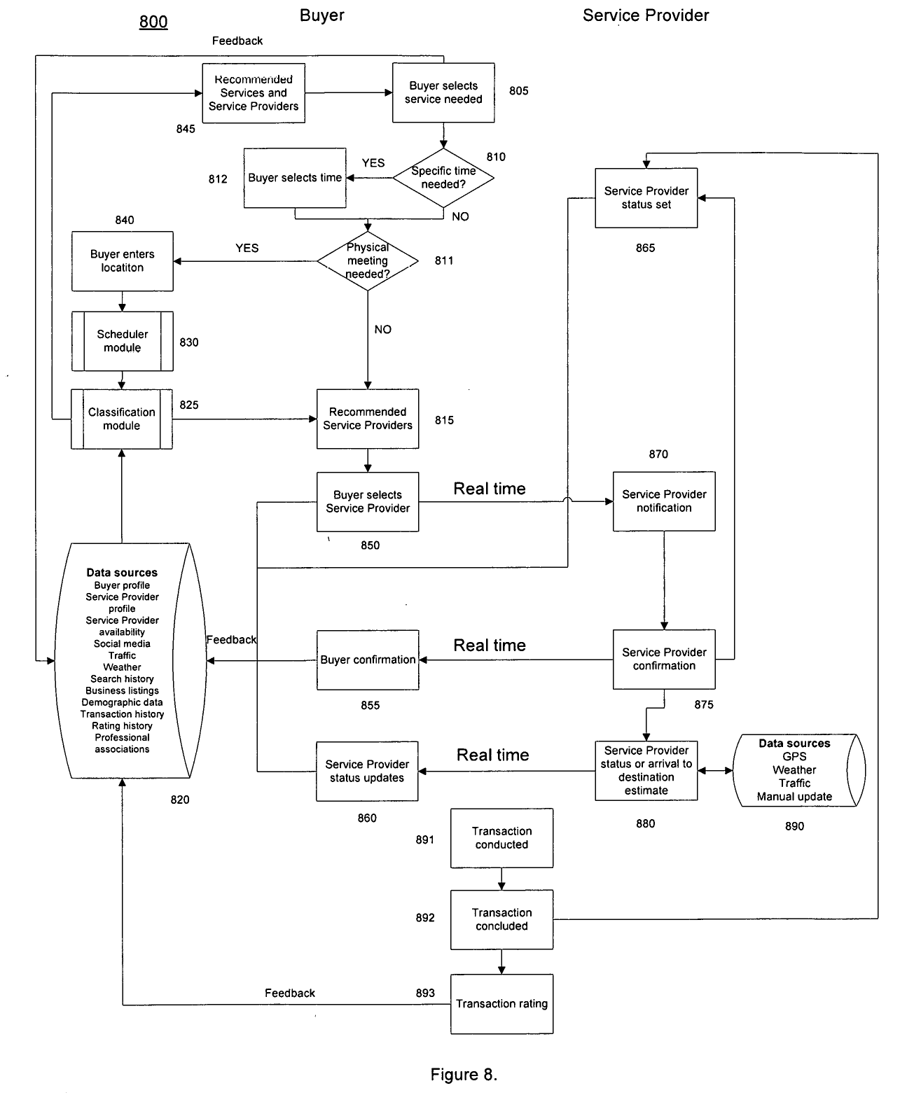

The discussion of regarding real estate agents and real estate buyers applies with equal force to real estate service requesters and/or real estate service providers (such as escrow agents, lenders, home inspectors, interior designers, and other service providers listed above). FIG. 8 illustrates a flowchart of an on-demand real estate service provider —service requester matching process according to embodiments. Described herein are meant to be illustrative examples rather than be limiting with respect to claimed subject matter. Likewise, an embodiment may be simplified to illustrate aspects and/or features in a manner that is intended to not confuse and/or hide claimed subject matter through specificity and/or details. Embodiments in accordance with claimed subject matter may include all of, less than all, or more than blocks 800-893. In embodiments, the order of blocks 800-893 may merely be an illustrative order and other orders may be possible.

In embodiments, computer-readable instructions executable by one or more processors or microcontrollers may perform the process described below. In embodiments, the computer-readable instructions may be executable by one or more processors on a mobile computing device (e.g., a smartphone, a tablet, a wearable computing device, etc.), a server computing device, a desktop computing device, a laptop computing device, or a combination thereof. In embodiments, in other words, the ODRESP application software may be resident on a mobile computing device, a server computing device, a desktop computing device, or a combination thereof. In embodiments, a graphical user interface or menu may be presented on a monitor of one of the computing devices discussed above, to allow a user or operator to select items to be executed or steps to be executed. In embodiments, a computing device may comprise voice recognition software to allow a user or operator to select actions and/or options to be performed via voice commands. In embodiments, as discussed above, the software may be referred to as an on-demand real estate service provider (ODRESP) software, ODRESP application software, an ODRESP system, or other similar terms.

In embodiments, in step 805, a real estate service requester may select a real estate product or a real estate service. In embodiments, it is important to identify when a service needs to be performed or product is of interest. In FIG. 6, for example, a buyer and/or customer may identify a real estate product or service of interest. In embodiments, a buyer or customer may then need a real estate service provider to perform the service or supply the product.

In embodiments, in step 810, a real estate service requester may determine if a specific time is needed to meet a real estate service provider. The description herein applies to real estate product suppliers (and product requesters). One significant advantage of the ODRESP system and/or software is the ability to quickly meet a real estate service provider and to get a real-time response (or a very quick response).

In embodiments, if a specific time is needed, a real estate service requester may select a time 812 to meet a real estate service provider. In embodiments, this meeting may be in person, over a video conference, over a chat line or over a mobile telephone call. In embodiments, this allows a real estate service requester to select a time (e.g., 30 minutes from now, an hour or two from present time) or a precise time in the future to meet the real estate service requester. Again, this is a significant advantage over present day systems where there is no specific time input for meetings with real estate agents. In embodiments, no time may be entered and in embodiments, if no time is entered, the ODRESP system and software may default to a meeting as soon as possible (or immediately).

In embodiments, a real estate service requester may select to have a physical meeting or in-person meeting 811. In embodiments, this means that the real estate service provider would agree to meet the real estate service requester at the selected or recommended real estate property 840 (if the service is to be performed at the real estate property). In embodiments, many real estate services do not need to be performed at the location of the real estate property (e.g., lenders, escrow agents, etc.) whereas other services need to be provided at the location of the real estate property (e.g., home inspectors, home appraisers, contractors, etc.) In embodiments, geographical coordinates (e.g., street address, latitude and longitude, track number) may be utilized to identify the real estate property.

In embodiments, if no in person meeting is necessary, in step 815, computer-readable instructions executed by the one or more computing devices may select and/or recommend one or more real estate service providers based on a variety of factors discussed below. In embodiments, artificial intelligence and deep learning may be utilized to analyze data from external and internal data sources to recommend the one or more real estate service providers. This is an advantage of the claimed subject matter in that the on-demand real estate service provider matching (ODRESP) system utilizes a variety of factors to determine and/or identify the recommended real estate service providers. In embodiments, these may be ratings from the Better Business Bureau, information or parameters received from a licensing server (for licensed professions such as contractors or financial-related service providers), social media information (including ratings, presence, comments regarding services provided), images of work completed and/or services provided, geographical location of owner and/or workers performing services, pricing regarding services provided and/or type of services provided compared to services requested, and many others. In embodiments, as shown in step 820, for example, the ODRESP system may utilize external or internal data sources such as, but not limited to, a real estate agent profile, a real estate buyer profile, social media profiles and/or social media usage data, a real estate agent's digital footprint, (e.g., other online sources besides social media platforms), property listings, traffic information, weather information, real estate agent's or buyer's search histories or search profiles, real estate provider trends or trending information; real estate service provider transaction histories; real estate service provider rating values, real estate service provider professional associations information or data. In embodiments, information about the neighborhood is not as important when selecting a real estate provider because you are selecting a service to be performed on real estate property and are not looking to purchase the real estate asset itself. In embodiments, the ODRESP system may utilize the classification module 825 to generate a plurality of classifications for the information, data and parameters described above. In embodiments, these classifications may be, for example, traffic classifications, weather classifications, service provider rating classification, home design-related classifications, professional association classifications. Depending on the services that are being provided, (e.g., home contractor or landscape designers or maintainers), the ODRESP system classification module 825 may utilize generate home design-related classifications based at least in part on architectural style parameters, landscaping style parameters, plant style parameters, outdoor living parameters, interior design parameters, interior layout parameters, kitchen style parameters, bathroom style parameters, family style parameters, entertainment style parameters, home theatre style parameters, and pool/sauna/jacuzzi style parameters. This is another significant advantage over present systems because the classifications described herein are not utilized to determine and/or recommend real estate service providers. In embodiments, these classifications may be real estate property classifications.

In embodiments, an ODRESP system may store relevant parameters, measurements, value and/or data in one or more ODRESP database servers. In embodiments, in step 620, one or more data sources may provide and/or store data, measurements, and/or profile values in one or more database servers or other computing devices. In embodiments, for example, social media platform database servers and social media platform application servers may update the ODRESP servers with information regarding one or more real estate service providers and/or one or more real estate service requesters. In embodiments, for example, real estate listing services database servers and real estate listing application servers or contractor servers or online rating servers may update the ODRESP database servers with information regarding one or more real estate service providers; and/or one or more real estate service requesters. In embodiments, for example, finance (e.g., banks, insurance, credit unions) database servers and finance application servers may update the ODRESP database servers with information regarding one or more real estate service providers and/or one or more real estate service requesters.

In embodiments, in step 825, computer-readable instructions (software) may be executable by one or more processors of the computing devices (e.g., the ODRESP software classification module) may create the real estate property classifications and neighborhood classifications described above and communicate this to the recommendation module 815. In embodiments, a recommendation module of the ODRESP software and/or system may perform artificial intelligence and/or machine learning and utilize the received home classifications received from the classification module 625 to generate one or more recommended real estate service providers that meet the real estate requesters' criteria (e.g., provide real estate services like the service requested by the real estate service requester and that can meet the real estate requester's time preference. In embodiments, for example, the buyer may be looking to obtain an FHA loan from a credit bureau in northern Orange County and request to have a call at 7:00 with a lender. In embodiments, the recommendation module 815 of the ODRESP software and/or system may utilize artificial intelligence and/or machine learning to generate a list of recommended real estate lenders that have classifications that meet the real estate buyer's preferences or input. For example, the recommendation module may search for lenders that 1) regularly handle FHA mortgages properties in the requested area; 2) have a positive rating; 3) have offices in Orange County; and 4) is available for a phone meeting at the requested time. In embodiments, based on the artificial intelligence and/or machine learning, computer-readable instructions may executable by one or more processors on one or more computing devices (e.g., the recommendation module 815 of the ODRESP software and/or system) may generate one or more real estate lenders and present the one or more recommended real estate lenders to the customer or client as recommended options. Again, this is a huge advantage in processing speed of real estate lender matching systems.

In embodiments, the real estate service requester may request a physical meeting with the real estate service provider. This provides an additional variable of having to find one or more recommended real estate service providers that are able to meet at the real estate property. Thus, other classifications may need to be utilized by the ODRESP recommendation module 815 in order to recommend one or more real estate service providers. In embodiments, a location of the selected real estate property 850 is input into a scheduler module 830. In embodiments, a scheduler module 830 may be receive as input real estate service provider's availability and also the real estate requester's schedule. In embodiments, the scheduler module 830 may provide this input to the classification module 825 and/or also the recommendation module 815 so that the recommendation may select one or more real estate service providers that are able to meet at the real estate property location, at or around the selected time and/or have favorable or similar classifications with respect to the real estate service requester.

In embodiments, in step 850, a real estate service requester may select a real estate service provider from the list of real estate service provider (or the one or more recommended real estate service providers). In embodiments, the computer-readable instructions may be executable by one or more processors on a computing device (e.g., the ODRESP software system) may provide and/or display one or more recommended real estate service providers that most closely matches (e.g., has classifications values that match) the searching criteria input by a user. In embodiments, the ODRESP software and/or system may display more than the recommended real estate service provider's names (e.g., some of the classification values may be displayed, as well as contact information, geographic region of service, number of references, types of houses worked on in last 30 days and/or any of the other parameters, measurements and/or information relevant to the real estate service provider and/or service requester.

In embodiments, in step 870, the computer-readable instructions executable by one or more processors of a computing device (the ODRESP software and/or system) may communicate in real-time or within a few seconds a selected notification to a real-estate service provider. In embodiments, for example, this may occur utilizing SMS messaging or other notification services that are transmitted out or pushed out from the requester computing device immediately after a real estate provider selection has been made. In embodiments, the selected real estate provider may confirm or accept the real estate requester selection and the real estate service provider computing device may communicate 675 a confirmation notification or message to the real estate requester computing device in real-time or within a few seconds after confirmation has occurred. In embodiments, this provides a real estate service requester with immediate or close to immediate confirmation that the selected real-estate service provider may meet them at a location to provide the service at the property location. For example, this may occur within seconds, within minutes or even 30 minutes. This is a significant improvement as to existing systems or software for matching real estate service providers and/or real estate service requester, where emails are sent to a number of real estate requesters and the real estate requesters may respond at a later time at their convenience. The subject matter described herein provides the customer with immediate feedback and reduces the amount of time spent communicating back and forth to set up a meeting or viewing of a potential real estate asset where the service will be provided. In alternative embodiments, the ODRESP software and system may communicate a customer or requester meeting request to a number of real estate service provider computing devices in real time. In this alternative embodiment, the service provider computing device that responds to the meeting request the quickest and also meets a number of other specified criteria (e.g., neighborhood expertise and/or home style expertise) may be assigned or referred to the real estate service requester.

In embodiments, in step 850, the computer-readable instructions executable by one or more processors of a customer computing device (e.g., the ODRESP software and/or system) may receive the real estate service provider confirmation notification and may generate a real estate service requester confirmation message or notification, which may be communicated 855 in real time or within a few seconds to the real estate computing device. In embodiments, a real estate service requester computing device may also send a feedback message and/or notification to the one or more database servers to update different records and/or parameters or information regarding the real estate service requester and/or the real estate service provider.

In embodiments, another feature of the ODRESP software and/or system is an ability to track a real estate service provider) as a meeting or event approaches and to provide status updates and/or notifications to a real estate service requester. In embodiments, the ODRESP software and/or system may determine 880 a status of the real estate service provider by communicating with external servers or computing devices, analyzing the received information and then calculating and/or determining the real estate service provider's status. In embodiments, external servers or computing devices may comprise GPS receivers or GPS measurement devices on real estate agent computing devices or nearby computing devices, weather servers or computing devices, and/or traffic servers or computing devices 890). In embodiments, the ODRESP system and/or software may periodically communicate with the external servers 890 (as described above) to obtain parameters, data, measurements and/or information. In embodiments, the ODRESP system and/or software may communicate in real-time with the external servers or computing devices at specified times before meeting times or events are to begin in order to provide the real estate service requester with real-time or immediate status updates of the real-estate service provider. In embodiments, in step 860, the ODRESP software of the customer or requester computing device may receive the real estate service provider status notification and thus be aware, in real-time of the location and/or arrival time of the real estate service provider and plan accordingly.

In embodiments, in step 875, computer-readable instructions executable by the one or more processors of the real estate service provider computing device may generate 860 a status notification for a real estate service provider at specified timeframes before a meeting or event is scheduled to occur and may communicate this information to the real estate service requester computing device (where it is displayed in the ODRESP software). In embodiments, the real estate service provider computing device may periodically generate a status notification (e.g., on the road, in heavy traffic, getting fuel) along with associated status parameters (e.g., how many miles or minutes a real estate agent is away from the event or meeting) and periodically communicate the generated status notification 860 to the service requester computing device utilizing the ODRESP software and/or system.

In embodiments, in step 891, the real estate service provider may perform the service requested by the service requested (e.g., either at the property or in offices or home offices). In embodiments, in step 892, the service that was requested may be completed by the service provider (e.g., the loan may be funded, the appraiser may generate the appraisal, or the contractor may fix the roof). In embodiments, the real estate service provider may update its status to available in the ODRESP software and/or system since the meeting, event and/or transaction or service may be concluded. In embodiments, the ODRESP software application on the real estate service provider may communicate 865 the updated status to the ODRESP system and/or software. In embodiments, a real estate service requester may determine 893 a rating for the real estate service provider. In embodiments, in step 893, the ODRESP software and/or system on the real estate requester computing device may communicate 820 the real estate service provider rating for the services provided or the transaction to the ODRESP system (e.g., the ODRESP application servers or the ODRESP database servers). In embodiments, the service requester's real estate service provider rating may also be utilized to update a service provider's transaction history, a ratings history, and/or a real estate service provider's profile, among other characteristics, in the ODRESP database servers and/or application servers 820.

In embodiments, the ODRESP system and/or software may automatically gather data, measurements, parameters and/or information for homes and/or neighborhoods and/or service providers from a number of external sources; automatically and potentially without human intervention, analyze the received data, measurements, parameters and/or information and generate a number of real estate classifications based on the analyzation and store the data, measurements, parameters and/or information in one or more memory devices of the ODRESP application servers and/or database servers. In embodiments, the ODRESP software and system may automatically make recommendations for real estate products or services based at least in part on the data, measurements, parameters and/or information in the one or more generated classifications for the homes, neighborhoods and/or service providers. In embodiments, the ODRESP system and/or software may make recommendations for real estate products or services automatically without any user invention. In embodiments, this may occur by the ODRESP system and/or software utilizing the user's profile and preferences and comparing this against the classifications generated by the classification module to determine real estate service providers 845 that are recommended for the real estate service requesters. In other words, once a real estate user has registered or created an account in the ODRESP software and/or system, the ODRESP software and/or system may generate 845 one or more recommended real estate services or products for the real estate user automatically without user input. In alternative embodiments, the ODRESP software and/or system may present a real estate service requester with an input screen allowing the real estate service requester to input selection criteria for a requested real estate service or product. In embodiments, the selection criteria may include the classifications previously generated by the ODRESP system and/or software as well as existing home searchable classifications such as service requested, product requested, geographic location, time for service performance or product delivery, date for service performance or product delivery, ratings requirements for service providers.

The ODRESP software and/or system may analyze many types of parameters, measurements, data and information when creating classifications for properties, neighborhoods, and/or service providers. In embodiments, the parameters, measurements, data and/or information may include but are not limited to home architectural style, home landscaping or hardscape style, home or landscape plant style, home outdoor living style, home interior design style, home interior layout style, home kitchen style, home bathroom style, type of family style, entertainment style, home theatre style, pool style, sauna style, and/or jacuzzi style. In embodiments, the parameters, measurements, data and/or information may include, but are not limited to entertainment data, parameters and information such as information and parameters related to shows, concerts, movies, museums, bars, cultural events, local events specific to an area (typically put on by local government and organizations). In embodiments, the parameters, measurements, data and/or information may include, but is not limited to recreation data, parameters and information, such as information and parameters related to parks, activities, trails, fitness centers, recreational facilities, organized recreational events, and/or organizational leagues. In embodiments, the parameter, measurements, data and/or information may include, but is not limited to educational data, parameters and information, such as information and parameters related to institutions and/or academic performance, such as schools, universities, vocational schools, and/or libraries. In embodiments, the parameters, measurements, data and/or information may include restaurants and restaurant style information and/or parameters; economic vitality information and/or parameters; industry type information and/or parameters, consumer services and consumer shop information and/or parameters; traffic pattern information, measurements and/or parameters; weather information, measurements and/or parameters; and/or natural disaster history and forecast information, measurements and/or parameters. In embodiments, the parameters, measurements, data and/or information may include, but not limited to safety information, parameters and/or data, including but not limited to crime parameters, measurements and information; fire and other emergency parameters, measurements and/or information, fire station and/or police station locations and/or size of stations or office; and/or urban development planning information and parameters, including but not limited to zoning, future urban development plans, and/or past urban development plans. In embodiments, the parameters, measurements, data and/or information may include demographic information and/or parameters, including but not limited to income, family size, education level, race and/or party affiliation parameters and/or information.

In embodiments, the real estate housing and/or neighborhood classifications generated by analyzing of the previously identified parameters, measurements, information and data may include, but are not limited to, standard searchable real estate property classifications such as square footage, number of bedrooms, size of lot, or number of bathrooms. These However, a unique aspect of the ODRESP system and/or software may be the creation of user-based and lifestyle-related classifications. In embodiments, artificial intelligent and/or machine learning can be utilized to assist in developing these user-based and lifestyle-related classifications and/or subjective classifications. In embodiments, Artificial intelligence/deep learning can take images and discern or extract specific characteristics regarding the image or images. For example, in embodiments, an image of a home may be utilized determine style, color, landscape style, types of plants and/or other parameters, which then may be put into home and/or neighborhood classifications. As a further example, knowledge of the surrounding neighborhood's businesses, parks, theaters, crime rates, development plans (e.g., parameters, measurements and/or information) may be extracted and then be used to develop classifications. These classifications can then be part of how the ODRESP software and system may uniquely recommend real estate products and services and/or how the ODRESP software and system may allow users to search for products and services. In embodiments, some of these software characteristics may include, but are not limited to home and/or neighborhood recreation characteristics, entertainment characteristics, family characteristics, pet characteristics, economic characteristics, food and/or restaurant characteristics; philosophical characteristics, political view characteristics, social view characteristics, tranquility style characteristics (e.g., serene, quiet, energetic, dark, bright, open, airy). TrendGrab (and its ODRESP software and/or system) may change how users search and find homes by using a holistic approach that uncovers what really matters to real estate buyers. Buying a home is so much more than square footage and the number of bathrooms. A home is where you go to rest, play, learn, unwind, escape, etc. and a home is a long term life journey that has the ability to shape people's lives.

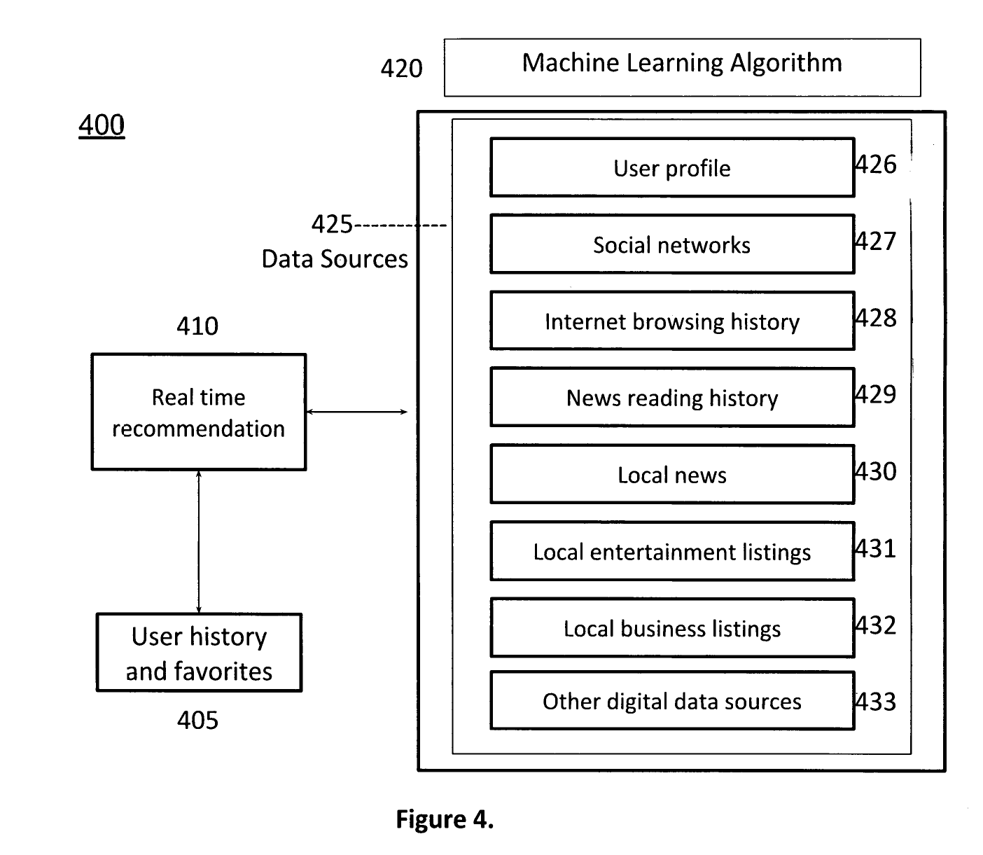

As discussed above, another feature of the ODRESP software application is the use of artificial intelligence and/or machine learning technologies, including but not limited to Deep Learning. In embodiments, the ODRESP software application and system, using artificial intelligence, may learn habits, tendencies and/or preferences of a real estate user in order for the ODRESP software application and system to make suggestions on the kinds of real estate services and/or products that the real estate user may be most interested in. FIG. 4 illustrates a diagram of utilizing machine learning or artificial intelligence to gather external data, analyze external data and utilize a user's history in order to develop a recommendation according to embodiments. FIG. 4 illustrates a user's history and favorite's module 405, a real time recommendation module 410 and a machine learning or artificial intelligence module 420 that is utilized in determining recommended user products or services according to embodiments. In embodiments, an artificial intelligence module 420 may interface, interact and communicate data, information, parameters or measurements with one or more data sources 425. In embodiments, the data sources 425 may comprise a user profile 426, a social network module 427, an internet browsing history module 428, a news reading history module 429, a local news module 430, a local entertainment listings module 431, a local business listings module 432 and/or other digital data sources 433. In embodiments, for example, the ODRESP software application and system may comprise a user history and favorites module 405 which may include real estate services utilized by the customer previously in the ODRESP software application and system along with favorites identified by the real estate user and/or the user machine learning algorithm 420. In embodiments, the ODRESP software application and system 400 may comprise a user real estate services recommendation module 410 that may communicate with the user history and favorites module 405 to determine a recommended service and a list other recommended real estate services.

In embodiments, the real estate services recommendation module 410 may communicate with and/or receive information from the machine learning algorithm module 420 in order to determine a recommended service and a list of other recommended real estate services. In embodiments, the real estate services recommendation module 410 of the ODRESP software may generate recommended services, based at least in part, on a user profile, a usage history of the ODRESP software and favorites identified by the real estate users. In embodiments, the real estate services real time recommendation module 410 of the ODRESP software application and system may make real estate products or services recommendations by obtaining additional information, parameters and measurements from the data sources available in the one or more database servers. In embodiments, the data sources may include a user's profile (e.g., created by the users) 426, a social network module 427 that is extracting information or receiving information from the user's digital footprint (e.g. social media postings, postings on the internet, other social networking platforms) as well as information, parameters and measurements from the internet browsing module 428 (which is extracting information from internet browsers utilized by the real estate users or receiving information from the internet browsers). In embodiments, additional data sources may assist the real estate services real time recommendation module 410 in determining a list of real estate services. In embodiments, the additional data sources may be the user profile module 426, a news reading module 429 (which extracts information as to what the real estate user has been reading online from online news sources or receives information from news sources that a user has signed up to receive), a local news module 430 (which extracts information from local news servers and/or receives information from local news servers); a local entertainment listings module 431 (which extracts information, parameters and/or measurements from entertainment-related servers such as movie-related servers or computing devices, concert-related servers or computing devices, recreational-related servers or computing devices, cultural-related servers or computing devices, etc. and/or receives such information automatically from these servers); a local business listings module 432 (which extracts information, parameters, and/or measurements from business-related servers, such as a chamber of commerce server, local business league servers, neighborhood business group servers and/or local merchant servers or computing devices and or receives information from these types of server); and/or other digital data sources 433 (which obtains real-estate related information, parameters and/or measurements from other computing devices or servers). In embodiments, the machine learning algorithm and/or real time recommendation module 410 may also extract information, parameters or measurements from other digital data sources 433 and/or receive information automatically from these servers.

In embodiments, the real estate services real time recommendation module 410 may utilize all, a portion of or some of this available digital identification data, parameters or measurements to 1) form or generate a list of recommended real estate products or services; 2) establish a more complete user profile and update the user profile and/or 3) add relevant information to a user favorite's module, which may or may not be the same as a real estate user profile module. The use of the real estate services real time recommendation module 410 leads to a greater understanding of the real estate user that may lead to more accurate suggestions. In embodiments, the ODRESP software and/or system may perform this analysis automatically in the background. In embodiments, for example, social network posts and images (obtained via the social network module) may indicate that a real estate user likes Hampton style houses and also the internet browsing module 428 may indicate that the user is part of Hampton-style housing chat group. Further, the news reading history module 429 may indicate that user is reading articles about San Clemente. In embodiments, the real estate services real time recommendation module 410 may utilize the parameters, measurements and information from the social network module 427, the news reading history module 429, and the Internet browsing module 428 and recommend a home contractor that can handle repairs or remodeling on a Hampton's style house. Thus, in situations like the problem above, the real estate real-time recommendation module 410 has utilized deep learning to analyze information from the data sources in order to provide a real time recommendation of a real estate agent. Similarly, in embodiments, a purchase history module 430 may identify that a number of smart lights and smart dimmers have been purchased by a real estate user. In addition, a local entertainment listing module 431 may identify that a real estate user has attended many movies lately and a social network module 427 has indicated that the user has made posts asking for pictures of a home entertainment systems. In embodiments, the real estate services real-time recommendation module 410 may receive this information and determine that a real estate user may be looking to install a home entertainment system and/or smart home devices and may base its recommendations of service providers on this information (e.g., contractors, landscape designers, outdoor living consultants and/or businesses who specialize in providing entertainment systems or theatres and/or products related thereto.)

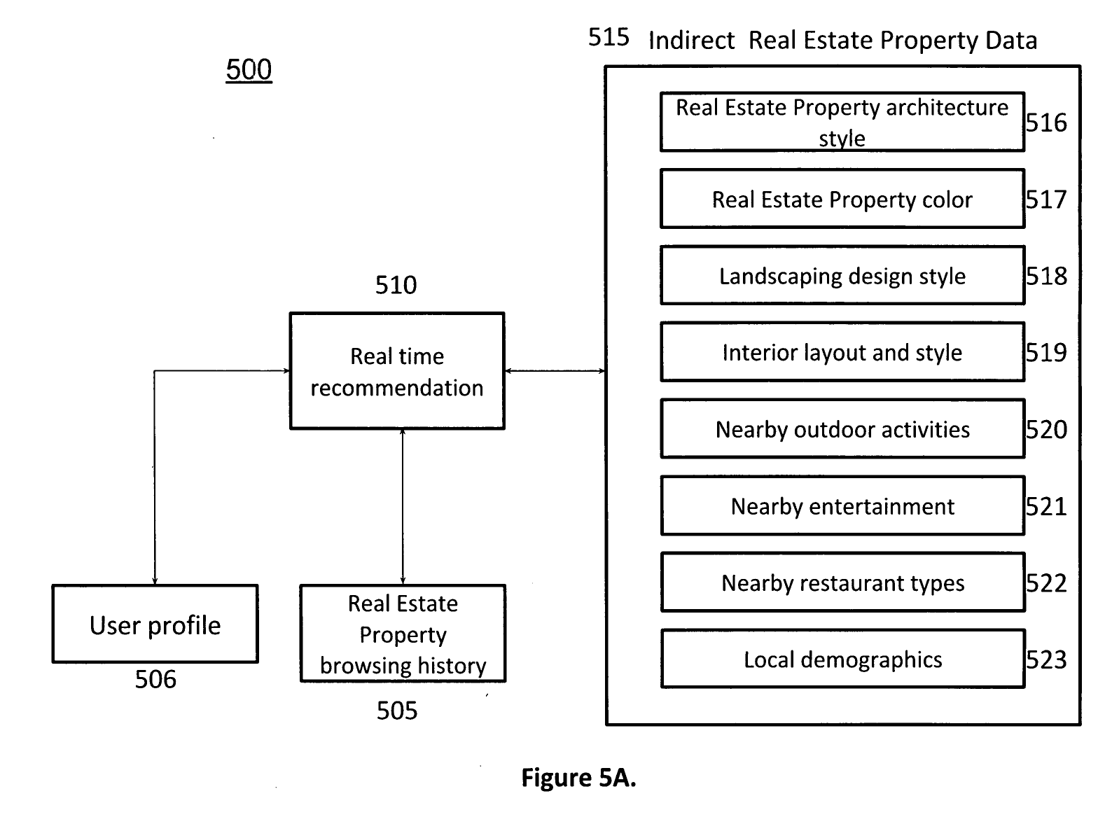

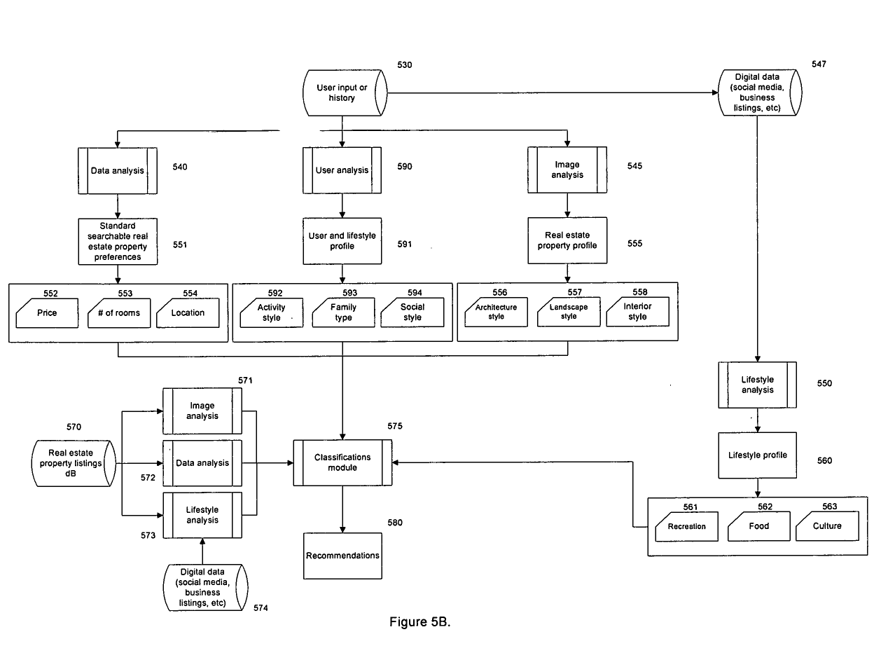

FIG. 5A illustrates a diagram illustrating artificial intelligence and deep learning in a home selection process accordingly to embodiments. In embodiment, the ODRESP application software and system 500 may comprise a real estate browsing history module 505, a real-time recommendation module 510, a user profile module 506 and various indirect or lifestyle real estate data modules 515. In embodiments, ODRESP application server and/or database server may house the real estate property browsing history module 505, the real-time recommendation module 510, the user profile and the various home data modules 515. In embodiments, the various real estate property data modules 515 may comprise a real estate property architectural style module 516, a color of real estate property module 517, a landscaping design style module 518, an interior layout and style module 519, a nearby outdoor activities module 520, a nearby entertainment module 521, a nearby restaurant type module 522, and/or a local demographics module 523. While these may be referred to as modules, the real estate property data modules 515 may also be records. With each of the above-highlighted modules, the module may receive data, measurements, parameters and information because the ODRESP software and system extracted it from the external data sources described above or because the information, measurements, parameters and/or data were provided or transferred to the ODRESP software and system. In embodiments, the real estate property data modules and/or records 515 may be updated by real estate user input and/or external sources such as an MLS database. In embodiments, the ODRESP software application may interface and/or interact with the real estate property browsing history module 505 to determine which real estate properties a real estate user has been viewing. In embodiments, the ODRESP software application may extract information, parameters and/or measurements from the real estate properties that have been browsed and may store the extracted information, parameter, and/or measurements in the real estate property data module 515. The information, parameters and/or measurements may be real estate property architecture, real estate property color, date real estate property was built, type of landscaping around real estate property, size of real estate property, interior color, nearby restaurants and/or distance to work In embodiments, for example, in the case of a real estate user interested in buying a real estate property, the ODRESP software application Deep Learning or AI module or executable instructions may extract images and/or available indirect information, measurements or parameters on the real estate properties browsed from within the ODRESP application (and also potentially from other browsers) to gain a better understanding of the kinds of real estate properties (and/or real estate property features and parameters) the real estate user prefers and is looking for. In embodiments, although some traditional information (which may be referred to as standard searchable parameters or classifications), such as square footage, number of rooms, etc., may have been utilized previously to select potential real estate properties of interest to a real estate user, the ODRESP software application and system (and/or the real time recommendation module 510) may utilize other and/or additional parameters, measurements and/or data to select and recommend real estate properties. For example, in embodiments, the ODRESP software application (and/or the real time recommendation module 510) may also consider real estate property specific parameters, measurements and/or data (e.g., color, architectural design, landscape design, or home builder) or location specific parameters, measurements and/or data (e.g., rankings of nearby schools, traffic congestion and patterns, crime trends, distance to work, available social activities (e.g., restaurants, nightclubs, movie theatres)). These may be referred to as lifestyle classifications, parameters and/or preferences. In embodiments, as mentioned above, the ODRESP software application and/or system (and/or the real estate property browsing history module 515) may obtain and/or extract parameters, measurements and information from various sources on the internet related to the properties viewed by the real estate user. In embodiments, ODRESP software application (and/or real estate real time recommendation module 510) may provide or form a more complete, holistic understanding of the real estate user preferences and additional criteria or parameters that may been considered when making a real estate property purchase. In embodiments, the ODRESP software application and system can then select and display real estate properties the software application thinks the real estate user may be most interested in without the user having to enter any search criteria. In embodiments, the ODRESP software application and system may automatically perform these actions and provide the real estate property selections to a real estate user at login, which allows the real estate user to see results rather than having to work through searching and selecting properties. This is an important feature of the ODRESP system because the user or purchaser may not need to select anything, the ODRESP system on its own identifies real estate properties of interest based on user-based factors and/or lifestyle-related factors. These actions are not performed at the present time and this is a specific and concrete improvement to the way prior systems used to operate. These systems never generated user-based factors and/or lifestyle-related factors and never invoked artificial intelligence or deep learning.

FIG. 5B is a flowchart illustrating a machine learning or deep learning process for the ODRESP software application to select real estate properties of interest for a real estate user. In embodiments, the ODRESP system and/or software may have included and/or may have input 530 by the user, parameters, data, measurements or information about the user. In embodiments, the ODRESP software may analyze the real estate user's history and/or input (specifically parameters, measurements and data) retrieved 540 from real estate related web sites that a user has been looking at or that a user entered into his or her profile. In embodiments, the ODRESP software and/or system may extract require real estate parameters, information, measurements and/or data (or have them input) and determine required real estate preferences 551 of the real estate user (which may also be referred to as “hard preferences” and/or “standard searchable preferences”). In embodiments, the ODRESP software and system may extract (or receive) for example, price preference 552, # or rooms preference 553 and/or location preference 554 parameters, data, measurements and/or information (and/or other parameters or information).

In embodiments, the ODRESP software and/or system may perform user analysis 590 on data received from the external data sources provided above. In embodiments, the ODRESP software and/or system may utilize artificial intelligence and/or deep learning algorithms in evaluating and analyzing the data, parameters, measurements and information in order to develop classifications that may be relevant or important for the real estate purchaser. In embodiments, the ODRESP software and/or system may create a user profile 591 (or enhance a user profile the real estate user has already created) by including relevant classification information and/or data, parameters, measurements and/or information. This is useful information to have when real estate properties are being selected for the real estate user. In embodiments, for example, the user profile, after execution of the AI and deep learning algorithms may include classifications including activity style classifications 592, family type classifications 593 and/or social style classifications 594 for the real estate user that may be helpful in the search for relevant real estate properties. This is a unique feature of the ODRESP software system because other real estate service providers do not include extracting and/or analyzing information or parameters about a user in order to select relevant real estate products or services and/or properties for the user.

In embodiments, the ODRESP software and/or system may analyze images 545 retrieved during the user's real estate searches, extracted from other external data sources and/or provided to the ODRESP software and system. In embodiments, the ODRESP software and system may extract 555 home or real estate property design parameters, measurements or data from the image analysis performed. In embodiments, the ODRESP software and system may extract soft or home design parameters, measurements, information and/or data such as color 556, home style 557 and/or landscape design 558 parameters, measurements, information and/or data. This is also a unique feature of the ODRESP software and system because other existing systems do not analyze images viewed by a user to help determine relevant characteristics and classifications in order to assist in providing real estate services or products to a customer.

In embodiments, the ODRESP software may also monitor 547 a digital footprint of a real estate user. In embodiments, a digital footprint may include chats, real estate forums, social media postings and/or or followers. In embodiments, the ODRESP software may perform a trend or lifestyle analysis 550 on data, measurements, parameters, and/or information retrieved from the real estate user's digital footprint or received from different computing devices associated with the digital footprint. In embodiments, the ODRESP software and/or system may utilize AI and/or deep learning algorithms to perform the lifestyle or trend analysis. In embodiments, in response to the lifestyle analysis, the ODRESP software and/or system may extract or calculate lifestyle preferences 560 for the real estate user. In embodiments, the lifestyle preferences may include, but are not limited to park 561, food or restaurant 562 and/or cultural 563 parameters, measurements and/or information and/or park, food/restaurant and/or culture classifications. Again, this is another advantage of the ODRESP software and system in that existing real estate services systems do not analyze a user's digital footprint to develop classifications that are used in selecting a real estate service (and in particular here) one or more real estate listings for the user.

In embodiments, as illustrated in FIG. 5B, the ODRESP system and software may also have modules that interface with the classifications module 575 and/or recommendations module 580. In embodiments, for example as illustrated in FIG. 5B, the classifications module may receive price classifications 552, # of room classifications 553, location classifications 554, activity style classifications 592, family type classifications 593, social style classifications 594, home style classifications 556, landscape style classifications 557, interior design style classifications 558, recreation classifications 561, food classifications 562 and/or culture classifications 563. The ODRESP software and system is not limited to the above-identified classifications, this is just an illustrative example for the recommendations of a real estate property. In embodiments, if these classifications are utilized by a real estate user, the classifications may also be referred to as preferences or preferences of the real estate user. In embodiments, a recommendation module of the ODRESP software and system may receive the generated classifications and/or preferences in a classifications module 575 as properties from that have been evaluated in order to generate one or more recommended real estate properties.

In embodiments, a real estate or home listings database server 570 may interface with an image analysis module 571, where the image analysis module identifies certain characteristics as well as classifications that the real estate listings may fall into or be a part of. In embodiments, these classifications may be home classifications and/or neighborhood classification. In embodiments, a real estate or home listings database server 570 may interface with data analysis module 572, where the data analysis module 572 analyzes data, information, parameters and/or measurements from the home listings database server 570 and also or separately determines home and neighborhood classifications for the real estate properties. In embodiments, for example, these may be the “hard classifications” or “standard searchable classifications” such as price, number or rooms, location. In embodiments, for example, there may be neighborhood classifications as well as user-type classifications such as real-estate property design-based classifications, activity style classifications, family style classifications and social style classifications. In embodiments, a real estate or home listings database server 570 may also interface with lifestyle analysis module 573, which also is interfacing with a digital data module 574. In embodiments, the lifestyle analysis module 573 may determine lifestyle real estate and neighborhood classifications (e.g., recreation classification, food classification, culture classification for the real estate properties provided by the real estate property listings database server 570. In embodiments, these classifications may be based on the information, parameters, measurements and data supplied by the digital database 574, which includes at least social media information and/or business listings information. In embodiments, the recommendations module of the ODRESP software and/or system may utilize the information in the classifications module 575 from the user and compare the user-based classifications or preferences to the classifications generated for the real estate properties by the image analysis module 571, data analysis module 572 and lifestyle analysis module 573 in order to generate a list of recommended real estate properties 580 for the real estate user. In embodiments, this may be performed automatically and/or in the background either when the real estate user is using the ODRESP software or alternatively when the real estate user is not online. In embodiments, there may be an option for a customer or user to select classifications or criteria (in addition to or separate from the ODRESP software and system generated classifications), compare these against the to the classifications generated for the real estate properties by the image analysis module 571, data analysis module 572 and lifestyle analysis module 573 in order to generate a list of recommended real estate properties 580 for the real estate user.

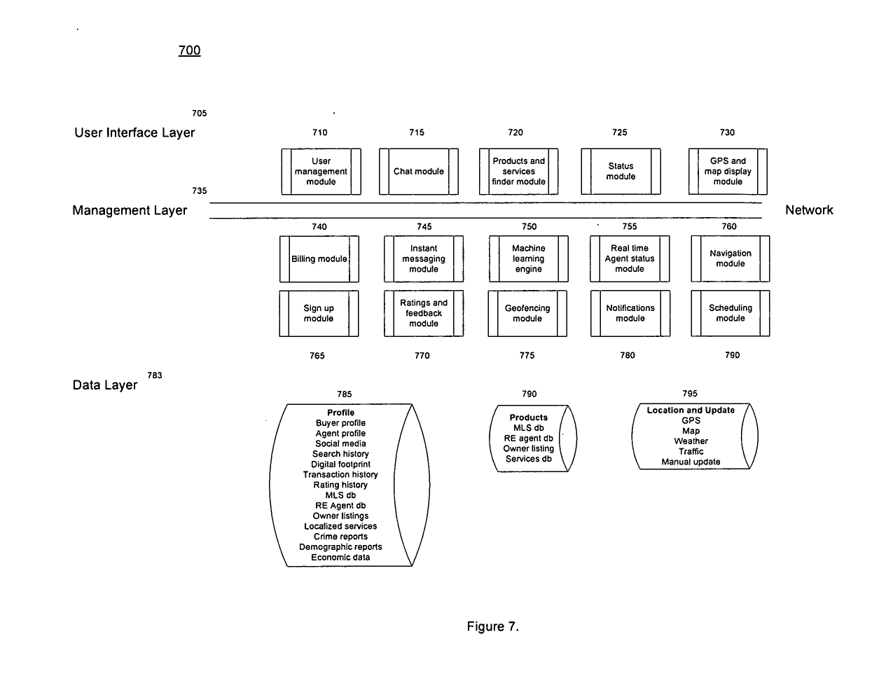

FIG. 7 illustrates a logical block diagram of the on-demand real estate service provide matching (ODRESP) system and/or software according to embodiments. In embodiments, the ODRESP system and/or software may include a user interface layer 705, a management layer 735 and/or a data or parameter layer 783. In embodiments, a real estate user may be able to interact or be controlled by the user interface layer. In embodiments, a user interface layer 710 may include a user management module 715 which manages real estate users utilizing the ODRESP system. In embodiments, a user interface layer 710 may comprise a chat module 715 that allows real estate users to chat with each other in the ODRESP software and/or system. In embodiments, a user interface layer 710 may comprise a products and services finder and services finder or search module 720 that allows real estate users to search for and find real estate products or services that are available, including but not limited to contractors, lenders, appraisers, escrow agents, landscape contractors, home remediation specialists, pest control providers, home inspectors, real estate listings, agents, and/or other related providers. In embodiments, a user interface layer 710 may comprise a status module 725, which may generate and/or calculates a real estate provider or real estate agent's status and/or ETA and displays such information within the ODRESP software application. In embodiments, a user interface layer 710 may also comprise a GPS and map display module 730, which may generate a real estate agent's or service provider's location and display such information on a map generated in the ODRESP software application and/or system.

In embodiments, the ODRESP software management layer 735 may comprise a billing module 740. In embodiments, a billing module 740 may generate invoices and communicate these to real estate users or service requesters and/or real estate agents or service providers who utilize the ODRESP software and/or system and/or purchase products or services from within the ODRESP software and system. In embodiments, the ODRESP software management layer 735 may comprise a sign up module 765 which provides a real estate user and/or real estate agent with an ability to sign up to utilized the ODRESP software. In embodiments, the ODRESP software management layer 735 may comprise an instant messaging module 745, where the instant messaging module allows real estate users and/or real estate agents to instant message each other and/or to instant message the ODRESP software administrative personnel. In embodiments, the ODRESP software management layer 735 may comprise a rating and feedback module 770 where a real estate user may provide feedback and/or a rating value for a real estate agent and/or another real estate service provider. In embodiments, an ODRESP software management layer 735 may comprise a machine learning engine 750 to perform deep analysis and identify trends based upon parameters, information, measurements and/or data in the ODRESP database server. In embodiments, the ODRESP software management layer 735 may comprise a geo-fencing module 775. In embodiments, the geo-fencing module 775 may allow a real estate user or service requester to identify an area in which the services may be requested and may also generate notifications that a real estate user, requester, provider and/or agent has left a specific area. In embodiments, a geo-fencing module 775 may also provide limits as to where the real estate user or service requester may request real estate services and/or also where a real estate agent or service provider is willing to work and/or provide services. In embodiments, the ODRESP software management layer 735 may comprise a real time agent status module 755 which interfaces with a status module 725 of the user interface module to provide the real estate agent's or service provider's status. In embodiments, the ODRESP software management layer 735 may comprise a notifications module 780. In embodiments, the notification module 780 may provide notifications to real estate users or service requesters and/or real estate agent's or service providers. In embodiments, the ODRESP software management layer 735 may comprise a navigation module 760 which may calculate locations of real estate users or service requestors and/or real estate agents or service providers. In embodiments, the navigation module 760 may interface with the user interface layer GPS and map display module 730.

In embodiments, the data or parameter layer 783 may be located and/or installed on an ODRESP database server. In embodiments, the data or parameter layer 783 may comprise a profile or storage module 785 where real estate data, parameters, measurements and information may be stored in database records. In embodiments, the profile or storage module 785 may include buyer profile measurements, parameters and/or data; agent profile measurements, parameters and/or data; social medial measurements, parameters and/or data; search history measurements, parameters, and/or data; digital footprint (e.g., social media postings) measurements, parameters and/or data; transaction history measurements, parameters and/or data; rating history measurements, parameters and/or data; MLS database measurements, parameters and/or data; real estate database measurements, parameters and/or data; owner listings measurements, parameters and/or data; localized services measurements, parameters and/or data; crime reports measurements, parameters and/or data; demographic reports measurements, parameters and/or data; and/or economic measurements, parameters and/or data. In embodiments, the data or storage module 783 may comprise a products module 790, where the products modules lists services or products available to the real estate user including but not limited to the MLS database, a real estate agent database and/or an owner listing services database. In embodiments, a data or storage layer 783 may comprise a locations and/or update module 795. In embodiments, the locations and/or update module 785 may store GPS, map, weather, and/or traffic data, parameters and/or measurements received or pulled from external servers such as GPS transceivers or satellites, map servers, weather servers and/or traffic servers.

In embodiments, a computing device may include one or more memory devices; one or more processors; and/or computer-readable instructions executable by one or more processors, the computer-readable instructions to cause the computing device to: receive a real estate product selection from real estate customer; receive a real estate meeting request time value and a real estate meeting location from the real estate customer; generate query including the real estate product selection, the real estate meeting request time value and the real estate meeting location; communicate the query including the real estate product selection, the real estate meeting request time value and the real estate meeting location to a database server; and receive, in real time from the database server, one or more recommended real estate agents based at least in part on the real estate product selection, the real estate meeting request time and the real estate meeting location. In embodiments, the computer-readable instructions executable by the one or more processors cause the computing device to: analyze in real time, and utilizing artificial intelligence, real estate agent profile information, parameters and/or measurements received from external data sources to generate the one or more recommended real estate agents. In embodiments, the computer-readable instructions executable by the one or more processors cause the computing device to: communicate a selection notification message in real time to a computing device of the selected real estate agent and/or receive a real estate agent confirmation message from the computing device of the selected real estate agent confirming the selected real estate agent is to provide the selected real estate server at approximately the real restate meeting request time. In embodiments, the computer-readable instructions executable by the one or more processors may cause the computing device to: receive a status message and a geographic location measurement from the computing device of the selected real estate agent; and display the received geographic location measurement in a map to identify a location of the selected real estate agent with respect to the real estate meeting location. In embodiments, the computer-readable instructions executable by the one or more processors cause the computing device to receive an estimated time of arrival at the real estate meeting location from the computing device of the selected real estate agent; and display the estimated time of arrival and the meeting request time to identify when the selected real estate agent is expected to arrive.

In embodiments, a computing device includes one or more memory devices; one or more processors; and computer-readable instructions stored in the one or more memory devices, accessed from the one or more memory devices and executable by the one or more processors to: receive one or more standard searchable real estate property preferences, or utilize existing standard searchable real estate property preferences, the one or more received standard searchable or existing standard searchable real estate property preferences or including a price preference, a number of rooms preference, or a location preference; receive one or more user based preferences, the one or more user based preferences including activity preferences, family preferences or social style preferences; receive one or more real estate property based design preferences, the or more real estate property based design classifications including a real estate property style preference, a landscape style preference or an interior style preference; compare the received one or more standard searchable real estate property preferences, the one or more user based preferences and the one or more real estate property based design preferences against real estate property classifications and neighborhood classifications for real estate properties in a real estate listings database; and generate a listing of recommended real estate properties, the listing of recommended real estate properties having real estate property classification values and neighborhood classification values closest to the one or more standard searchable real estate property preferences, the one or more user based preferences and the one or more real estate property based design preferences. In embodiments, the computer-readable instructions may be further executable by the one or more processors to: receive or retrieve one or more lifestyle-based preferences, the one or more lifestyle preferences including recreation preferences, food establishment preferences or cultural preferences; and utilize the one or more lifestyle-based preferences in generating the listing of recommended real estate properties. In embodiments, the computer-readable instructions may be executable by the one or more processors to utilize artificial intelligence algorithms to analyze a user profile and generate the one or more user based preferences based at least in part on the analyzation of the user profile.ln embodiments, the computer-readable instructions may be further executable by the one or more processors to utilize artificial intelligence algorithms to analyze images associated with the user to generate the one or more real estate property based design preferences. In embodiments, the computer-readable instructions may be further executable by the one or more processors to analyze social media data and parameters of the user, business-related data and parameters or neighborhood-related data and parameters to generate the one or more lifestyle-based preferences. In embodiments, the computer-readable instructions may be further executable by the one or more processors to utilize artificial intelligence to perform image analysis, data analysis and lifestyle analysis on the real estate properties in the real estate property listings database to generate the property classification values and the neighborhood classification values that are compared with the standard searchable real estate property preferences, the real estate property-based design preferences, the lifestyle-based preferences or the user-based preferences.

In embodiments, the computing device may include one or more memory devices; one or more processors; computer-readable instructions stored in the one or more memory devices, accessed from the one or more memory devices and may be executable by the one or more processors to: receive real estate-related parameters, information and measurements from social media related computing devices, either through crawling and extracting the parameters, information and measurements from the social media related computing devices or receiving through communications the real estate-related parameters, information and measurements; receive real estate-related parameters, information and measurements from search histories in the browsing software programs utilized by a real estate user, either through extracting the parameters, information and measurements from the browsing software or receiving, through communications with the browsing software program, the real estate related parameters, information and measurements; and analyze the real-estate related parameters, information and measurements from the social media related computing devices and the real-estate related parameters, information and measurements from the search histories to generate one or more real estate classifications and one or more neighborhood classifications, wherein the real estate classifications are utilized by a user to filter real estate products or services.

The invention as described in this document has been do so in an illustrative manner. As such it is understood that any terminology or examples used in this application are intended to help clarify the invention and provide additional description. In no way does the terminology or examples limit the invention. Many modifications and variations of the present invention are possible in light of the above teachings. Real time real estate products and services may include a wide variety of applications directly or indirectly associated with any part of the home buying and selling process including but not limited to pre and post sales products and services. For example, the invention may be used for home moving, notary, and home decorating services. It is therefore to be understood that within the scope of the appended claim, the invention may be practiced otherwise than as specifically described. The invention is defined by the claims.

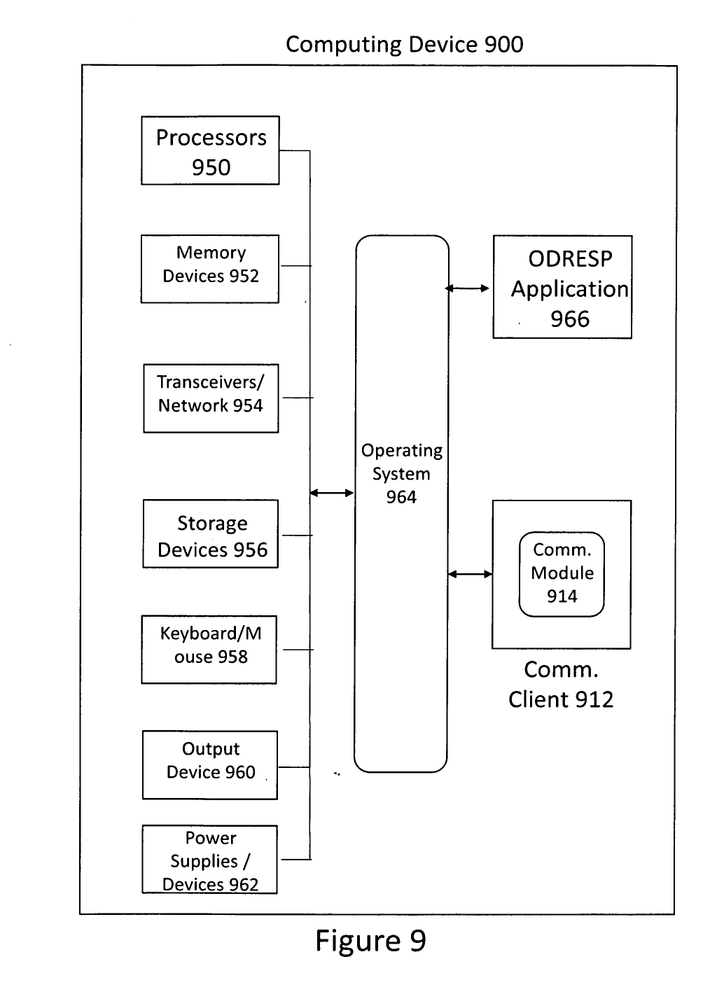

FIG. 9 illustrates a computing device utilized in an ODRESP system according to embodiments. In embodiments, these computing devices may include real estate customer/service provider computing devices (e.g., 115 from FIG. 1A); agent/service provider computing devices (e.g., 125 from FIG. 1A), ODRESP application servers 105, ODRESP database servers 110 from FIG. 1A), as well as other servers or computing device mentioned herein. As shown in the specific example of FIG. 9, computing device 900 includes one or more processors 950, one or more memory devices 952, one or more communication transceivers or communication network interfaces 954, one or more storage devices 956, one or more input devices 958, one or more output devices 860, and one or more power sources 962. Mobile communications device or computing device 900 may also include one or more operating systems 964 that are executable by mobile communications device or computing device 900. Mobile communications device or computing device 900, in one example, may further include communication client 912 and one or more application software including but not limited to ODRESP software 966 that are also executable by mobile communications device or computing device 900. Each of components 950, 952, 954, 956, 958, 960, 962, 964, 966, and 912 may be interconnected (physically, communicatively, or operatively) for inter-component communications.

In embodiments, processors 950, in one example, are configured to at least implement functionality or process instructions for execution within client device 912 or 914. For example, one or more processors 950 may be capable of processing instructions stored in one or more memory devices 952 or instructions stored on one or more storage devices 956.

In embodiments, one or more memory devices 952, in one example, is configured to store information within mobile communications device or computing device 900 during operation. One or more memory devices 952, in some examples, is described as a computer-readable storage medium. In some examples, one or more memory devices 952 may be used as a temporary memory, although one or more memory devices 952 may be used as long-term storage. In embodiments, one or more memory devices 952, in some examples, is described as a volatile memory, meaning that one or more memory devices 952 does not maintain stored contents when mobile communications device or computing device 900 is powered off. Examples of volatile memories include random access memories (RAM), dynamic random access memories (DRAM), static random access memories (SRAM), and other forms of volatile memories known in the art. In some examples, one or more memory device 952 is used to store program instructions for execution by one or more processors 950. In embodiments, one or more memory devices 952, in one example, is used by software or applications running on mobile communications device or computing device 900 (e.g., application 866 and/or one or more other applications 914) to temporarily store information during program execution.

In embodiments, storage devices 956, in some examples, may also include one or more computer-readable storage media. In embodiments, storage devices 956 may be configured to store large amounts of information. In embodiments, storage devices 956 may further be configured for long-term storage of information. In some examples, storage devices 956 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Mobile communications device or computing device 900, in some examples, also includes one or more communication transceivers or communication network interfaces 954. Mobile communications device or computing device 900 in one example, utilizes transceiver or communication network interfaces 954 to communicate with external devices via one or more networks, such as one or more wireless networks. One or more communication transceivers or network interfaces 954 may be a network interface card, such as an Ethernet card, an optical transceiver, a radio frequency transceiver, or any other type of device that can send and receive information. Other examples of such network interfaces and/or transceivers may include Bluetooth, 3G and WiFi radios in mobile computing devices as well as USB. In some examples, mobile communications device or computing device 900 utilizes one or more communication and network interfaces 954 to wirelessly communicate or communicate via wires or cables with an external device such as a server device or server computing device, a mobile phone, or other networked computing devices.

Mobile communications device or computing device 900, in one example, also includes one or more input devices 958. Input devices 958, in some examples, are configured to receive input from a user through tactile, audio, or video input. Examples of input devices 958 may include a presence-sensitive screen, a mouse, a keyboard, a voice responsive system, video camera, microphone or any other type of device for detecting a command from a user. In some examples, a presence-sensitive screen includes a touch-sensitive screen. In embodiments, one or more output devices 960 may also be included in mobile communications device or computing device 900. In embodiments, output device 960, in some examples, may be configured to provide output to a user using tactile, audio, or video output. Output devices 960, in one example, may include a presence-sensitive screen or a touch screen. In embodiments, output devices 960 may utilize a sound card, a video graphics adapter card, or any other type of device for converting a signal into an appropriate form understandable to humans or machines. In embodiments, additional examples of output devices 960 may include a speaker, a cathode ray tube (CRT) monitor, a liquid crystal display (LCD), or any other type of device that can generate intelligible output to a user.

In embodiments, mobile communications device or computing device 900, in some examples, may include one or more power sources or power supplies 962, which may be rechargeable and provide power to mobile communications device or computing device 800. In embodiments, the one or more power sources or power supplies 962 may be one or more batteries. In embodiments, the one or more batteries may be made from nickel-cadmium, lithium-ion, or any other suitable material. In another example, in embodiments, the one or more power sources or power supplies 962 may include a power supply connection that receives power from a power source external to mobile communications device or computing device 900. The one or more power sources or power supplies 962 may provide less power to communication client 912 when the virtual communication session is in an inactive, or ambient state, than when the virtual communication session is in an active state than when it is in an inactive state.

In embodiments, one or more application software packages or modules 966 may provide mobile communications device or computing device 900 with additional functionality. In embodiments, an application software package may include ODRESP application software. In embodiments, this additional functionality may include, for example, a social media application, an on-demand real estate service provider matching system and software application, web browsing, calendar, contacts, games, document processing, or any other functionality performed by a computing device such as mobile communications device or computing device 900. In embodiments, one or more software application packages 966 may cause at least one of output devices 960 to display some elements of a graphical user interface (GUI). In embodiments, mobile communications device or computing device 900 may include one or more operating systems 964. Operating systems 964, in some examples, may control the operation of components of mobile communications device or computing device 900. For example, operating system 964, in one example, may facilitate the interaction of communication client 912 with processors 950, memory device 952, communication or network interfaces 954, storage devices 956, input devices 958, output devices 960, and power sources or power supplies 962. In embodiments, communication client 912 may include communication module 914. In embodiments, one or more software applications 966 (including the ODRESP software application, communications client 912, and communication module 914 may each include at least one of computer-readable program instructions or data that are executable by one or more processors 950 of a mobile communications device or computing device 900. For example, in embodiments, communication module 914 may include computer-readable instructions executable by one or more processors 950 that cause communication client 8912 to perform one or more of the operations and actions described in the present disclosure.

In some examples, in embodiments, at least one of application software packages 966, communication client 912, or communication module 914 may be a part of one or more operating systems 864 operating and being executed by one or more processors 950 of a mobile communications device or computing device 900. In some examples, in embodiments, communication client 912 may receive input from one or more input devices 958 of mobile communications device or computing device 900. In embodiments, communication client 912 may, for example, receive at least one of audio or video information associated with a communication session from other computing devices participating in the communication session.

Aspects of the present disclosure may improve social interaction because users may indicate when they are actually available to engage in a communication session. In addition, the richness of the communicated reactions, e.g., video or audio representations of user expressions, may further improve the social interaction because such representations may convey more information with less user effort. The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), flash memory, magnetic or optical data storage media, and the like. In some examples, an article of manufacture may comprise one or more computer-readable storage media. In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

The above disclosure is sufficient to enable one of ordinary skill in the art to practice the invention, and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A computing device, comprising:
one or more memory devices;
one or more processors;
computer-readable instructions executable by one or more processors, the computer-readable instructions to cause the computing device to:
receive real estate product selection from real estate customer;
receive real estate meeting request time value and real estate meeting location from the real estate customer;
generate query including the real estate product selection, the real estate meeting request time value and the real estate meeting location;
communicate the query including the real estate product selection, the real estate meeting request time value and the real estate meeting location to a database server;
receive, in real time from the database server, one or more recommended real estate agents based at least in part on the real estate product selection, the real estate meeting request time and the real estate meeting location.

2. The computing device of claim 1, the computer-readable instructions executable by the one or more processors to cause the computing device to:
analyze in real time, and utilizing artificial intelligence, real estate agent profile information, parameters and/or measurements received from external data sources to generate the one or more recommended real estate agents.

3. The computing device of claim 1, the computer-readable instructions executable by the one or more processors to cause the computing device to:
communicate a selection notification message in real time to a computing device of the selected real estate agent.

4. The computing device of claim 3, the computer-readable instructions executable by the one or more processors to cause the computing device to:
receive a real estate agent confirmation message from the computing device of the selected real estate agent confirming the selected real estate agent is to provide the selected real estate server at approximately the real restate meeting request time.

5. The computing device of claim 4, the computer-readable instructions executable by the one or more processors to cause the computing device to:
receive a status message and a geographic location measurement from the computing device of the selected real estate agent; and
display the received geographic location measurement in a map to identify a location of the selected real estate agent with respect to the real estate meeting location.

6. The computing device of claim 2, the computer-readable instructions executable by the one or more processors to cause the computing device to:
receive an estimated time of arrival at the real estate meeting location from the computing device of the selected real estate agent; and
display the estimated time of arrival and the meeting request time to identify when the selected real estate agent is expected to arrive.

7. A computing device, comprising:
one or more memory devices;
one or more processors;
computer-readable instructions stored in the one or more memory devices, accessed from the one or more memory devices and executable by the one or more processors to:
receive one or more standard searchable real estate property preferences, or utilize existing standard searchable real estate property preferences, the one or more received standard searchable or existing standard searchable real estate property preferences or including a price preference, a number of rooms preference, or a location preference;
receive one or more user based preferences, the one or more user based preferences including activity preferences, family preferences or social style preferences;
receive one or more real estate property based design preferences, the or more real estate property based design classifications including a real estate property style preference, a landscape style preference or an interior style preference;
compare the received one or more standard searchable real estate property preferences, the one or more user based preferences and the one or more real estate property based design preferences against real estate property classifications and neighborhood classifications for real estate properties in a real estate listings database; and
generate a listing of recommended real estate properties, the listing of recommended real estate properties having real estate property classification values and neighborhood classification values closest to the one or more standard searchable real estate property preferences, the one or more user based preferences and the one or more real estate property based design preferences.

8. The computing device of claim 7, the computer-readable instructions further executable by the one or more processors to:
receive or retrieve one or more lifestyle-based preferences, the one or more lifestyle preferences including recreation preferences, food establishment preferences or cultural preferences;
utilize the one or more lifestyle-based preferences in generating the listing of recommended real estate properties.

9. The computing device of claim 8, the computer-readable instructions further executable by the one or more processors to utilize artificial intelligence algorithms to analyze a user profile and generate the one or more user based preferences based at least in part on the analyzation of the user profile.

10. The computing device of claim 8, the computer-readable instructions further executable by the one or more processors to utilize artificial intelligence algorithms to analyze images associated with the user to generate the one or more real estate property based design preferences.

11. The computing device of claim 8, the computer-readable instructions further executable by the one or more processors to analyze social media data and parameters of the user, business-related data and parameters or neighborhood-related data and parameters to generate the one or more lifestyle-based preferences.

12. The computing device of claim 8, the computer-readable instructions further executable by the one or more processors to utilize artificial intelligence to perform image analysis, data analysis and lifestyle analysis on the real estate properties in the real estate property listings database to generate the property classification values and the neighborhood classification values that are compared with the standard searchable real estate property preferences, the real estate property-based design preferences, the lifestyle-based preferences or the user-based preferences.

13. A computing device, comprising:
one or more memory devices;
one or more processors;
computer-readable instructions stored in the one or more memory devices, accessed from the one or more memory devices and executable by the one or more processors to:
receive real estate-related parameters, information and measurements from social media related computing devices, either through crawling and extracting the parameters, information and measurements from the social media related computing devices or receiving through communications the real estate-related parameters, information and measurements;
receive real estate-related parameters, information and measurements from search histories in the browsing software programs utilized by a real estate user, either through extracting the parameters, information and measurements from the browsing software or receiving, through communications with the browsing software program, the real estate related parameters, information and measurements; and
analyze the real-estate related parameters, information and measurements from the social media related computing devices and the real-estate related parameters, information and measurements from the search histories to generate one or more real estate classifications and one or more neighborhood classifications, wherein the real estate classifications are utilized by a user to filter real estate products or services.

14. The computing device of claim 13, the computer-readable instructions further executable by the one or more computing devices to:
receive real estate-related parameters, information and measurements from news reading histories on news organization computing devices, either through extracting the parameters, information and measurements from the news organization computing devices or receiving through communications with the news organization computing devices, the real estate-related parameters, information and measurements; and
analyze the real estate-related parameters, information and measurements from the news reading histories or the news organization computing devices to further assist in generating the one or more real estate classifications and the one or more neighborhood classifications used to filter real estate products or services.

15. The computing device of claim 13, the computer-readable instructions further executable by the one or more computing devices to:
receive entertainment-related parameters, information and measurements from local entertainment computing devices, either through extracting the entertainment-related parameters, information and measurements from the local entertainment computing devices or by receiving, through communications with the local entertainment computing devices, the entertainment-related parameters, information and measurements; and
analyze the received entertainment-related parameters, information and measurements to further assist in generating the one or more real estate classifications and the one or more neighborhood classifications used to filter real estate products or services.

16. The computing device of claim 13, the computer-readable instructions further executable by the one or more computing devices to:
receive business-related parameters, information and measurements from local business computing devices, either through extracting the business-related parameters, information and measurements from the local business computing devices or by receiving, through communications with the local business computing devices, the business-related parameters, information and measurements; and
analyze the received business-related parameters, information and measurements to further assist in generating the one or more real estate classifications and the one or more neighborhood classifications used to filter real estate products or services.

17. The computing device of claim 13, the computer-readable instructions further executable by the one or more computing devices to:
receive safety-related parameters, information and measurements from local police, fire or public safety computing devices, either through extracting the safety-related parameters, information and measurements from the local police, fire or public safety computing devices or by receiving, through communications with the local police, fire or public safety computing devices, the safety-related parameters, information and measurements; and
analyze the received safety-related parameters, information and measurements to further assist in generating the one or more real estate classifications and the one or more neighborhood classifications used to filter real estate products or services.

18. The computing device of claim 13, the computer-readable instructions further executable by the one or more computing devices to:
receive demographic-related parameters, information and measurements from local governmental or public record computing devices, either through extracting the demographic-related parameters, information and measurements from the local governmental or public record computing devices or by receiving, through communications with the local governmental or public record computing devices, the demographic-related parameters, information and measurements; and
analyze the received demographic-related parameters, information and measurements to further assist in generating the one or more real estate classifications and the one or more neighborhood classifications used to filter real estate products or services.

19. The computing device of claim 13, the computer-readable instructions further executable by the one or more computing devices to:
receive recreation-related parameters, information and measurements from local park, sport-related or governmental computing devices, either through extracting the recreation-related parameters, information and measurements from the local park, sport-related or governmental computing devices or by receiving, through communications with the local park, sport-related or governmental computing devices, the recreation-related parameters, information and measurements; and
analyze the received recreation-related parameters, information and measurements to further assist in generating the one or more real estate classifications and the one or more neighborhood classifications used to filter real estate products or services.

20. The computing device of claim 13, the computer-readable instructions further executable by the one or more computing devices to:
receive education-related parameters, information and measurements from local education computing devices, either through extracting the education-related parameters, information and measurements from the local education computing devices or by receiving, through communications with the local education-related computing devices, the education-related parameters, information and measurements;
receive traffic condition parameters, information and measurements from local traffic condition computing devices, either through extracting the traffic condition parameters, information and measurements from the local traffic condition computing devices or by receiving, through communications with the local traffic condition computing devices, the traffic condition parameters, information and measurements;
receive cultural-related parameters, information and measurements from local cultural computing devices, either through extracting the cultural-related parameters, information and measurements from the local cultural computing devices or by receiving, through communications with the local cultural computing devices, the cultural-related parameters, information and measurements;
receive commerce and economic-related parameters, information and measurements from local economic computing devices, either through extracting the commerce and economic-related parameters, information and measurements from the local economic computing devices or by receiving, through communications with the local economic computing devices, the commerce and economic-related parameters, information and measurements; and
analyze the received a) education-related parameters, information and measurements; b) traffic condition parameters, information and measurements; c) cultural-related parameters, information and measurements and/or d) commerce and economic-related parameters, information and measurements to further assist in generating the one or more real estate classifications and the one or more neighborhood classifications used to filter real estate products or services.
